(19) United States
(12) Patent Application Publication
(10) Pub. No.: US 2003/0203731 A1
(43) Pub. Date: Oct. 30, 2003

(54) Cellular telephone and method of displaying account information

(75) Inventors: John J. King, Wheaton, IL (US); Christina J. King, Wheaton, IL (US)

Correspondence Address: John J. King, 1481 Cantigny Way, Wheaton, IL, 60187, US

(73) Assignee: LAVAFLOW, LLP, Wheaton, IL

(21) Appl. No.: 10/424,381

(22) Filed: Apr. 28, 2003

Related U.S. Application Data
(60) Provisional application No. 60/378,631, filed on May 6, 2002.
(60) Provisional application No. 60/376,145, filed on Apr. 29, 2002.

(51) Int. Cl. H04M 11/00; H04B 1/38

(52) U.S. Cl. 455/407; 455/566

(57) ABSTRACT

A cellular telephone adapted to display account information is disclosed. The cellular telephone comprises a control circuit; a receiver coupled to the control circuit, the receiver receiving bill information by way of a wireless communication network; and a display coupled to the control circuit, the display showing the bill information.

### CLAIM FOR PRIORITY

Applicants claim priority on Application Serial No. 60/376,145, entitled METHOD OF AND APPARATUS FOR PROVIDING INFORMATION TO A WIRELESS COMMUNICATION DEVICE, filed Apr. 29, 2002, and Application Serial No. 60/378,631, entitled METHOD OF AND APPARATUS FOR PROVIDING INFORMATION TO A WIRELESS COMMUNICATION DEVICE, filed May 6, 2002.

### FIELD OF THE INVENTION

This disclosure relates generally to wireless communication devices, networks, and services, and more particularly to devices, networks, and methods for providing information to a wireless communication device.

### BACKGROUND OF THE INVENTION

Since the discovery of two-way radios, wireless communications has continuously evolved. Over the last two decades, cellular telephones have become increasingly popular and widely used. As the number of users has increased, the rates for airtime have decreased, further expanding the market of users of cellular telephones. However, the increasing number of users of cellular telephones and the lower rates for services have put financial pressure on wireless service providers. In particular, wireless service providers have had to invest in new networks to increase capacity to handle the additional users, while their profit margins have decreased due to the reduced rates for service.

In order to address capacity and profit margin issues caused by the increased number of subscribers and the reduced margins on services, wireless service providers have adopted digital cellular telephone networks, such as TDMA, CDMA or GSM networks. Such networks not only have enabled more users on a network, but also have enabled additional features, such as SMS, EMS or MMS messaging, which are well known in the art of cellular communications. More importantly, GPRS or EGDE functions on networks have provided a considerable increase in data or information content to wireless communication devices. GPRS is generally a feature of current digital cellular telephone networks that enables an “always-on” service for wireless communication devices. That is, GPRS enables the display of data or information on a cellular telephone instantaneously and continuously in a fashion which is similar to a computer user on the Internet using a T-1 line, which is well known in the art.

Similarly, in order to increase the sale of cellular telephones, manufacturers and wireless service providers have been promoting new cellular telephones with color displays. Such new cellular telephones are intended to increase sales both through the sale of phones to new subscribers or replacement phones for existing subscribers. The color displays on the new cellular telephones enable the transfer of new types of data, such as pictures or photographs.

However, while such phones are being offered, no user interfaces, networks or services are providing features which can both increase the enjoyment of the wireless communication device or increase revenues for service providers. That is, while such improvements as color displays on cellular telephones and new networks such as GPRS exist, conventional cellular telephones and services provided by wireless service providers are significantly deficient in providing new content which is adapted to be displayed by a color display on a cellular telephone or transmitted on an “always-on” network, such as a GPRS network. Similarly, the user interfaces of such conventional cellular telephones are not adapted to display the new content which could be provided to color screens on cellular telephones. More importantly, many parties who enable the provision of content and services to users of wireless communication devices are missing significant revenue opportunities. That is, because of the lack of features for wireless communication devices and services provided by wireless service providers, wireless service providers, content providers, Internet service providers, and others are missing opportunities for generating additional revenue for their content or services.

Accordingly, there is a need for an improved wireless communication device for enabling the display of advanced content and features on wireless communication networks.

There is a further need for improved wireless communication networks for providing advanced content to a user of a wireless communication device.

There is a further need for improved wireless communication service features for providing advanced content to user of a wireless communication device.

Finally, there is a need for methods of generating revenue for advanced wireless communication networks which provide service to new wireless communication devices, such as cellular telephones having color displays.

Accordingly, there is a need for devices, networks and methods for providing advanced picture content to a wireless communication device.

### BRIEF DESCRIPTION OF THE DRAWINGS

FIG. 1 is a system-level diagram of a network providing advanced picture content according to the present invention;

FIG. 2 is a block diagram of a service provider interfacing with a device according to the present invention;

FIG. 3 is a block diagram of a wireless communication device according to the present invention;

FIG. 4 is a block diagram of a wireless communication network according to the present invention;

FIG. 5 is a block diagram of an alternate embodiment of a wireless communication device according to the present invention

FIG. 6 is a planned view of an exemplary user interface of the wireless communication device of FIG. 5 according to the present invention;

FIG. 7 is a block diagram of an alternate embodiment of a wireless communication network according to an alternate embodiment of the present invention;

FIG. 8 is a timing diagram showing the relationship between parties in the wireless communication network of FIG. 7;

FIG. 9 is a series of displays showing user interfaces, content and services for wireless communication devices provided by wireless communication service providers according to the present invention;

FIG. 10 is a flowchart showing a method of providing advanced picture content to a wireless communication device according to the present invention;

FIG. 11 is a more detailed flowchart showing a method for providing advanced picture content to a wireless communication device according to the present invention;

FIG. 12 is a flowchart showing methods of selecting advanced picture content for display on a wireless communication device according to the present invention;

FIG. 13 is a flowchart showing a method of receiving information associated with an advanced picture content feature on a wireless communication device according to the present invention;

FIG. 14 is a flowchart showing a method of generating revenue by a service provider providing advanced picture content to a wireless communication device according to the present invention;

FIG. 15 is a flowchart showing a method for selecting options of an advanced picture content service feature of a wireless communication service according to the present invention;

FIG. 16 is a flowchart showing a method of remotely selecting features of an advanced picture content service according to the present invention;

FIG. 17 is a flowchart showing a method of providing advanced picture content to a wireless communication device according to an alternate embodiment of the present invention;

FIG. 18 is a flowchart showing a method of accessing information associated with an advanced picture content service according to one aspect of a user interface according to the present invention;

FIG. 19 is a flowchart showing a method of enabling bill payment for services provided to a wireless communication device according to the present invention;

FIG. 20 is a flowchart showing a method of selecting services provided by a wireless service provider to a wireless communication device according to the present invention;

FIG. 21 is a flowchart showing a method of providing screensaver content to a wireless communication device according to the present invention;

FIG. 22 is a flowchart showing a method of providing screensaver content to a wireless communication device according to an alternate embodiment of the present invention;

FIG. 23 is a flowchart showing a method of providing a real time screensaver service to a wireless communication device according to the present invention;

FIG. 24 is a flowchart showing a method of providing a slide show feature to a wireless communication device according to the present invention;

FIG. 25 is a flowchart showing a method of providing slide show content to a wireless communication device according to an alternate embodiment of the present invention;

FIG. 26 is a flowchart showing a method for providing real time slide show content to a wireless communication device according to the present invention;

FIG. 27 is a flowchart showing a method of providing location based information to a wireless communication device according to the present invention;

FIG. 28 is a flowchart showing a method of providing location-based information to a wireless communication device according to the present invention;

FIG. 29 is a flowchart showing a method of providing real-time location-based information to a wireless communication device;

FIG. 30 is a flowchart showing a method of synchronizing information between a wireless communication device and another device according to the present invention;

FIG. 31 is a flowchart showing a method of reducing power consumption in a wireless communication device according to the present invention;

FIG. 32 is a flowchart showing a method of customizing content provided to a wireless communication device using advanced picture content features according to the present invention;

Turning now to FIG. 33, a flow chart shows a method of creating advice picture content on a wireless communication device;

Turning now to FIG. 34, a more detail method for creating an advanced picture content file on a wireless communication device as show; and

Turning now to FIG. 35, a flow chart shows a method of creating a slide show on a wireless communication device according to the present invention.

### DETAILED DESCRIPTION

The present disclosure provides numerous unique and novel features, user interfaces, services, communication networks, wireless communication devices, and revenue-generating business methods related to providing information and/or picture file content to wireless communication devices. Unlike conventional wireless communication devices, such as cellular telephones or pagers, which rely primarily on the transmission of voice or simple data respectively, the methods and devices of the present disclosure enable the transmission of advanced content to novel wireless communication devices by way of novel wireless communication networks. In particular, the present disclosure describes wireless communication devices, preferably having color displays, which display information, such as advanced picture content, from a wireless service provider. Advanced picture content refers to the display of one or more picture files using display functions, such as screensavers, slide shows, location-based information, streaming videos, the display of information related to picture files, or both. Picture files means any type of icon, graphic, digital image or photograph, design, background screen, etc., stored in any type of standard or proprietary format, such as JPEG, GIFF, TIFF, etc. Similarly, the present disclosure describes networks for enabling the transmission of advanced picture content from a wireless communication network to a wireless communication device. Further, the present disclosure provides new and unique methods for generating revenue by providing advanced picture content to a wireless communication device.

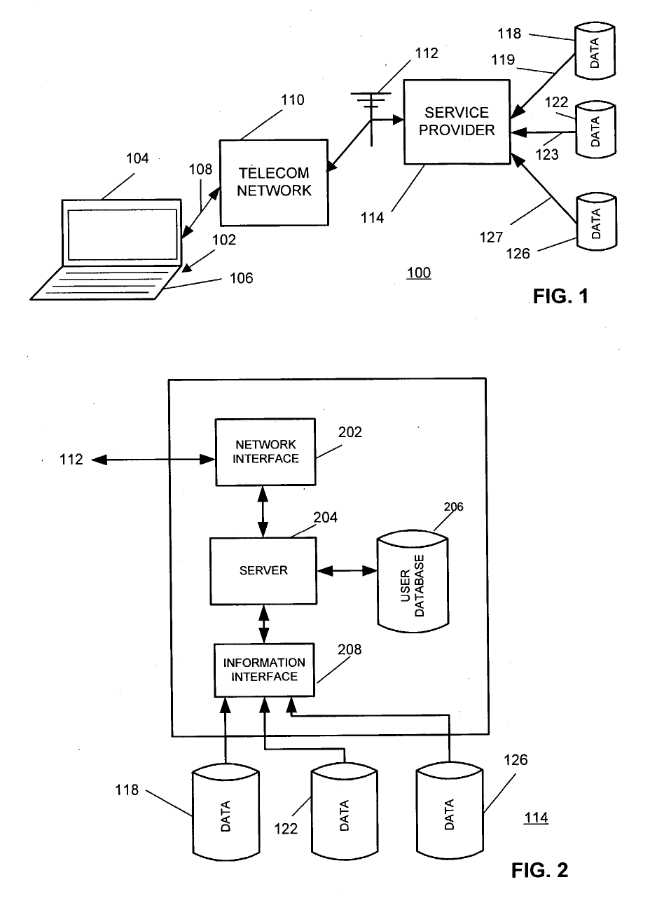

Turning now to FIG. 1, a system level diagram shows an exemplary network 100 for providing advanced picture content according to the present invention. Generally, a communication device 102, preferably having a display 104 and a keyboard 106, is coupled by a data connection 108 to a telecommunications network 110. Communication device 102 could be any wireless communication device having a display, such as a cellular telephone or personal digital assistant (PDA). Similarly, data connection 108 could be any wireless link that is well known in the art. Telecommunications network 110 is coupled by another data connection 112 to a service provider 114 having access to a plurality of databases 118, 122, and 126 by way of communication links 119, 123 and 127 respectively. The data connection 112 could for example be a wireline connection to a service provider, such as an Internet Service Provider (ISP), or the service provider could be associated with the wireless communications network. Alternatively, the databases could reside within the service provider or the wireless communications network. Although FIG. 1 represents one example of a network for implementing the system for providing advanced picture content described in this specification, it should be understood that one skilled in the art could apply Applicant's invention to a variety of other suitable networks.

Turning now to FIG. 2, an exemplary block diagram of service provider 114 according to the present invention is shown. Service provider 114 preferably includes a network interface 202 that receives requests from and transmits data to communication device 102 by way of data connection 112. The network interface provides a request to a server 204. Server 204 preferably has access to a user database 206, which database 206 could store picture files, information associated with the picture files, user profiles, or other information that may be useful or necessary to an end user. For example, the user database could include statistical information in an end user's profile to help determine appropriate information, such as targeted advertisements, to provide to a user.

An information interface 208 generally coordinates communications with databases 118-126 and provides information to server 204. The information interface could extract information, such as targeted advertisements from a variety of information providers, depending upon the end user's needs as set forth in the end user's profile. Alternatively, the functionality of information interface 208 could be incorporated in server 204. While the exemplary block diagram of service provide 114 shows one configuration of a service provider enabling the methods described in the present disclosure, other configurations of a service provider could be employed.

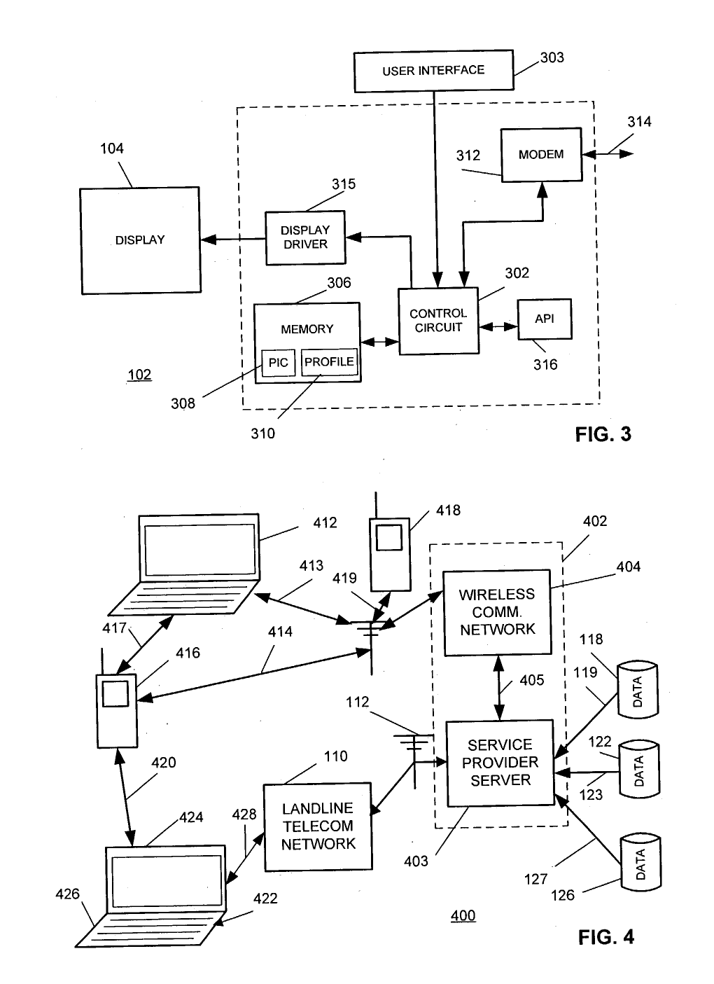

Turning now to FIG. 3, a block diagram of a communication device 102 according to the present invention is shown. The device preferably includes a control circuit 302, such as a microprocessor, microcontroller, ASIC or some other circuit or integrated circuit to control the device. A memory device 306 could also be coupled to the control circuit to retain picture files 308 or user profile information 310. As discussed in reference to FIG. 2, such information could also be stored outside of the communication device (such as user database 206 shown in FIG. 2) and provided to the device by a modem 312. Modem 312, which could comprise an RF communication circuit, transmits and receives information by of an I/O port 314 which could be a suitable means such as an antenna, infrared, BlueTooth, I.E.E.E. 802.11 or some other wired or wireless protocol. A display driver 315 enables picture files and information to be displayed on display 104. User interface 106 also enables a user to provide input to the control circuit necessary to access the Application Program Interfaces (APIs) 316 to display picture files and information according to the present disclosure. The user interface 303 also enables entry of data into the wireless communication device 102. Such APIs and other software necessary for requesting and receiving content specific information and displaying advanced picture content can be written in any suitable language, including but not limited to C++ or Java, or any derivates thereof.

Turning now to FIG. 4, a block diagram shows a wireless communication network according to the present disclosure. In particular, the wireless communication network 400 comprises a wireless service provider 402. Wireless service provider 402 preferably comprises a service provider server 403, which is coupled to a wireless communication network 404 by way of a communication link 405. The service provider server 403 could be operated by the same entity and on the same premises as the wireless communication network 404, or could be separate from the wireless communication network 404. For example, the wireless service provider 402 could be any cellular telephone service provider, personal communications services (PCS) service provider, or some other wireless service provider, which provides both the wireless communication network 404 having the base stations and telecommunication equipment (which are well known in the art to enable the transmission of RF communication signals on a wireless communication network), as well as the service provider server 403 having the necessary servers to enable the features and services of the present disclosure. Alternatively, the service provider servers could be provided by a separate entity from a wireless communication network 404 according to the present disclosure.

In addition to communicating with the landline communication network 110, the wireless service provider 402 communicates with wireless communication devices, such as the wireless communication device 416, by way of a communication link 414. For purposes of this disclosure, a wireless communication device is any portable radio frequency (RF) communication device, such as a cellular telephone, pager, or combined cellular telephone/personal digital assistant. Because such devices are easily transportable and accessible by a user in any situation, a user can frequently and conveniently benefit from the advanced picture content. In the category of wireless communication devices, such devices could be separated into wireless data communication devices, such as pagers, wireless voice communication devices, such as cellular telephones, or wireless voice/data communication devices, which are the most common and include, for example, digital cellular telephones, PCS telephones or other wireless telephony devices having data capabilities, such as SMS, EMS or MMS. In contrast, portable or laptop computers that can be adapted to enable wireless communication, would not be considered wireless communication devices, but rather portable computers.

Further, the wireless service provider 402 could communicate with such as a portable computer 412, having a display and keypad, by way of a communication link 413, and the wireless communication device 416 could communicate by a communication link 418. Communication link 418 could be, for example, a wired connection, such as a standard RS-232 connection, or some other wired protocol, or a wireless connection, such as a local area network connection or a wide area network connection. The local area network connection could be, for example, a Bluetooth connection, an IEEE 802.11 connection, an infrared connection, or some other low-power, wireless local connection. Similarly, the wireless communication device 416 can communicate with a landline networked computer by way of a communication link 420. The communication link 420 could also be such a wired or wireless connection as communication link 418. Alternatively, a landline networked computer 422, also having a keypad 422 and a display 424, could communicate with the wireless communication device 416 by way of a communication link 428 to the land line telecom network 110 and the wireless communication network 404. Finally, a second wireless communication device 418, similar or identical to wireless communication device 416, could communicate with any other device in the wireless communication network 400, including the wireless communication device 416, by way of a wireless communication link 419, or any other similar communication link shown with respect to wireless communication device 416. As will become apparent in reference to the remaining figures, the elements of the wireless communication network 400 can be used to implement many of the features, services, user interfaces, and other aspects of the present disclosure.

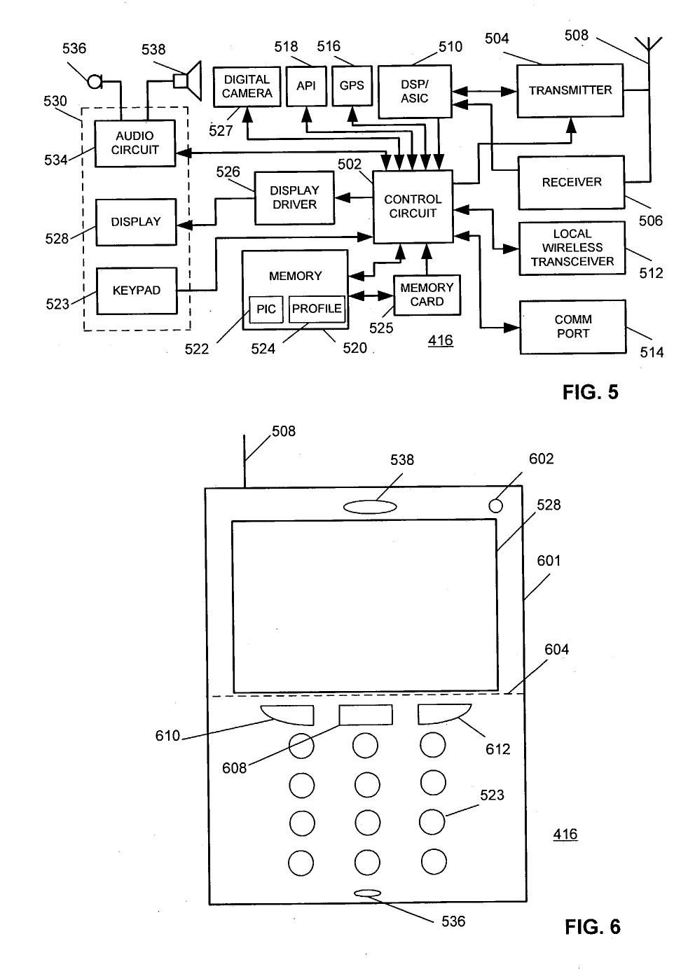

Turning now to FIG. 5, a block diagram of the Wireless Communication Device 416 is shown. In particular, a Control Circuit 502 is coupled to a Transmitter 504 and to receiver 506. The transmitter and receiver are coupled to an Antenna 508 for transmitting and receiving RF communication signals, as is well known in the art. The Wireless Communication Device 416 preferably includes a Digital Signal Processor (DSP)/Application-Specific Integrated Circuit (ASIC) 510. The DSP/ASIC 510 is coupled to the Transmitter 504 and the Receiver 506, and is adapted to enable communication of digital signals between the control circuit and the Transmitter 504 and the Receiver 506. The Wireless Communication Device 416 also preferably includes a Local Wireless Transceiver 512. The Local Wireless Transceiver 512 could be any low-power local wireless transceiver which would enable short range communication to another device. The Local Wireless Transceiver 512 could communicate on any wireless protocol, such as infrared, Bluetooth, IEEE 802.11, or some other local wireless communication protocol. A Communication Port 514 is also preferably coupled to the Control Circuit 502 to enable a wired communication link to another device, such as the Communication Device 102. The Communication Port 514 could enable communication between the devices by way of any wired communication protocol, such as RS-232, or some proprietary protocol.

A Global Positioning System (GPS) Unit 516 is preferably coupled to the Control Circuit 502 to provide location information to the control circuit. That is, the GPS Unit 514 can provide the location information related to the location of the Wireless Communication Device 416, as is well known in the art. Although a GPS unit is shown, any other circuit or software for providing location information of the Wireless Communication Device 416 could be employed according to the present disclosure. For example, triangulation using base stations in a wireless communication network, as is well known in the art, could be used to provide less accurate location information related to the Wireless Communication Device 416. An Application Program Interface (API) 518 is also coupled to the Control Circuit 502 to provide an application interface, as is well known in the art.

A Memory 520 comprising a Picture Memory 522 and a Profile 524 is also preferably coupled to the control circuit. As will become apparent in reference to the remaining figures, various data, such as picture files, information data, and other user information could be stored in the Picture Memory 522. Similarly, user data could be stored in the Profile Portion 524. Memory 520 could be incorporated in a single memory device, or a plurality of memory devices, as is well known in the art. In particular, a combination of memory devices, such as a read-only memory (ROM), a random-access memory (RAM), or an EEPROM could be employed, as is well known in the art, depending upon the nature of the information stored in the memory. Finally, a memory card 525, such as a compact flash card or multimedia memory card, would enable the storage of one or more picture files or other information taken by a digital camera 527 or stored in the memory 520, or provided to control circuit 522 for display or downloaded to the memory 520 for later display.

Finally, a User Interface 530 is coupled to the Control Circuit 502 to enable a user of the Wireless Communication Device 416 to transmit and receive information with a device by way of a communication network. In particular, a Keypad 523 is coupled to the Control Circuit 502 to enable entry of information which can be provided by way of a Display Driver 526 to a Display 528. The keypad could be a numeric keypad having alphanumeric-entry capability, or could be a full QWERTY keypad for easier entry of alphanumeric characters. Display 528 is preferably a color display, such as a liquid crystal display (LCD), to enable the display of advanced content, such as picture files. The Control Circuit 502 is also coupled to Audio Circuitry 534, which includes a Microphone 536 and a Speaker 538. The Control Circuit 502 and Audio Circuit 534 also preferably enable voice-activated communication, including voice recognition communication as well as speakerphone capability. Such voice recognition circuitry could be employed in the wireless communication device or at the service provider. Although an Exemplary Wireless Communication Device 416 is shown, the features and functions of the Wireless Communication Device 416 could be employed in other functional arrangements, or by other functional blocks which are well known in the art. The Wireless Communication Device 416 as shown in FIG. 5 is merely an exemplary device showing the fundamental features of a wireless communication device employing the features and functions described in the present disclosure.

Turning now to FIG. 6, an exemplary user interface and housing for the Wireless Communication Device 416 is shown. In particular, a Housing 601 receives the circuitry shown in the block diagram of the wireless communication device of FIG. 5 and includes a recess for receiving a Power Button 602 and a recess for showing the Display 528. The Antenna 508 preferably extends from the housing, while recesses enable sound from the Speaker 538 to be heard by the user, as well as input to the Microphone 536. Recesses in the housing also expose keys of a conventional numeric Keypad 523, as well as selector keys, such as a Menu Selector 608 or Selectors 610 and 612 for providing forward and backward selection within a menu, or other functions which are well known in the art. The Menu Selector 608 could be, for example, a rocker arm, a dial having a push selection feature, a “joy-stick,” or some other conventional selector. Finally, an optional hinge 604 enables the wireless communication device 416 to be folded to form a “clamshell” style device.

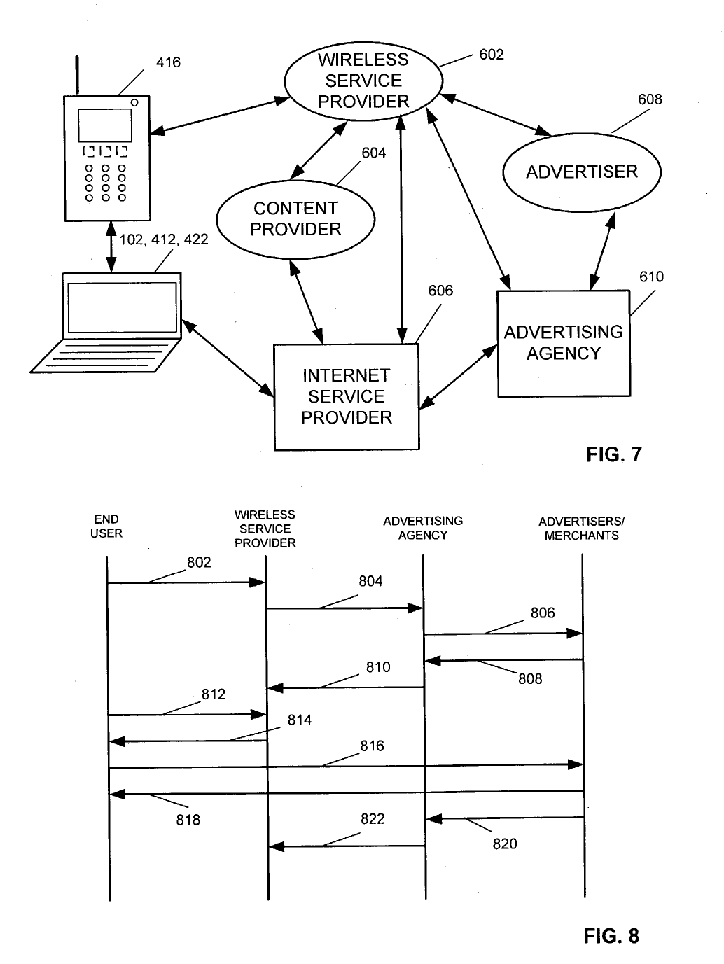

Turning now to FIG. 7, a wireless communication network having a number of elements which implement features or provide services according an alternate embodiment of the present invention is shown. In particular, a Wireless Service Provider 602 communicates with a Content Provider 604 to receive content. The Content Provider 604 could provide any type of content, such as news, weather, sports, points of interest, location-based content, or any other variety of content which the Wireless Service Provider 602 could provide to its subscribers by way of the Wireless Communication Device 416. The Content Provider 604 could also communicate with an Internet Service Provider 606 to provide content to a Communication Device 102, 412, 422 or to the Wireless Communication Device 416 by way of the Communication Device 102. Alternatively, the Wireless Service Provider 602 could communicate directly with an Internet service provider to provide information to the Wireless Communication Device 406. Finally, the Wireless Service Provider 602 could communicate directly with an Advertiser 608, or indirectly with the Advertiser 608 by way of an Advertising Agency 610. The Advertiser 608 or Advertising Agency 610 could provide advertisements to the Wireless Service Provider 602, which could in turn be provided to the Wireless Communication Device 416 or the Communication Device 102, 412, 422, according to methods, features, or services of the present disclosure.

Turning now to FIG. 8, a timing diagram shows an example of a business method for enabling the communication of content, such as advanced picture content to a Wireless Communication Device 416. In particular, an end user of the wireless communication device enters into a contract or other arrangement for the provision of services with the Wireless Service Provider 602 at a step 802. The wireless service provider also enters into a contract or other provisioning arrangement with an Advertising Agency 610 at a step 804. The advertising agency also enters into an agreement with an Advertiser 608 at a step 806. The Advertiser 608 preferably provides advertisement to the Advertising Agency 610 at a step 808. The advertising agency in turn provides the advertisements to the Wireless Service Provider 602 at a step 810. The user of the Wireless Communication Device 416 then communicates with the Wireless Service Provider 602 at a step 812. For example, the user of the wireless communication device could request certain services which require either content from the Content Provider 604 or an Internet Service Provider 606, or agree to receive advertisements from either Advertiser 608 or Advertising Agency 610 as compensation for also receiving information or advanced picture content at a step 812. Accordingly, the wireless service provider provides content and/or advertisement to the Wireless Communication Device 416 at a step 814.

As will be described in more detail in reference to the remaining Figures, the user can then access additional information or purchase a product from the Advertiser 806 at a step 816. In response to the request from the end user, the Advertiser 608 provider information and/or products to the end user at a step 818. The advertiser then provides the advertising agency with a percentage of revenue generated at a step 820, and the Advertising Agency 610 provides a percentage of revenue generated to the wireless service provider at a step 822. Although the various steps are shown in a particular order, the order of the various steps could vary as should be apparent. Similarly, steps could be omitted or equivalent transactions as to those shown could be employed according to the present disclosure.

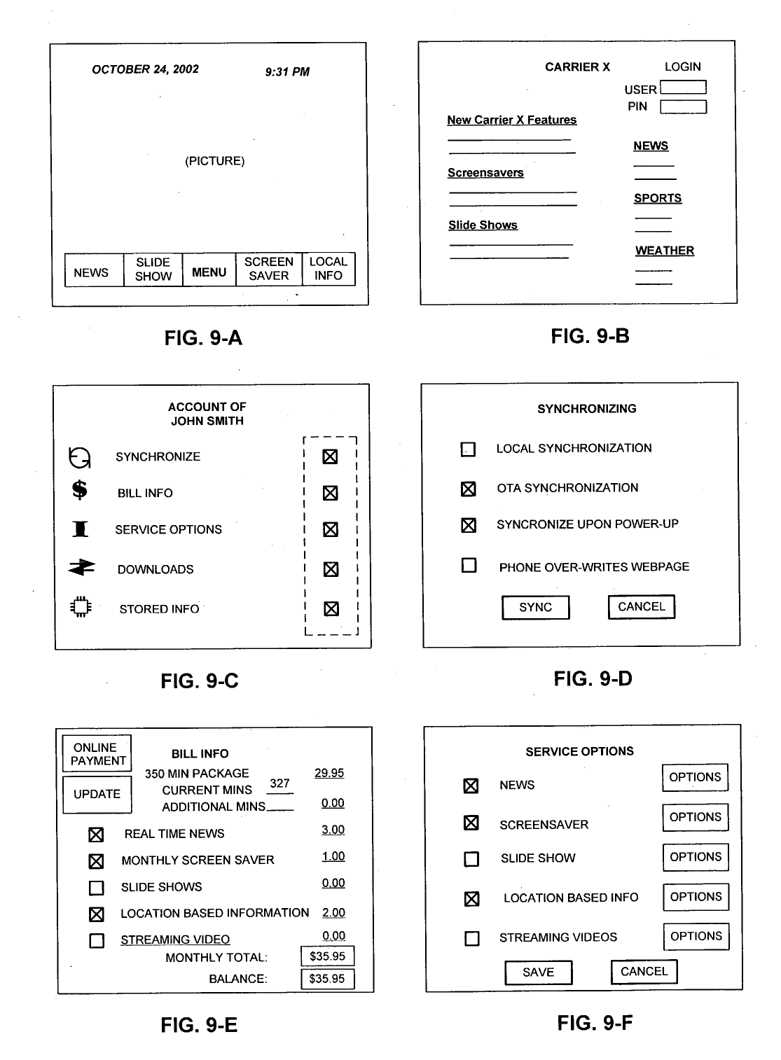

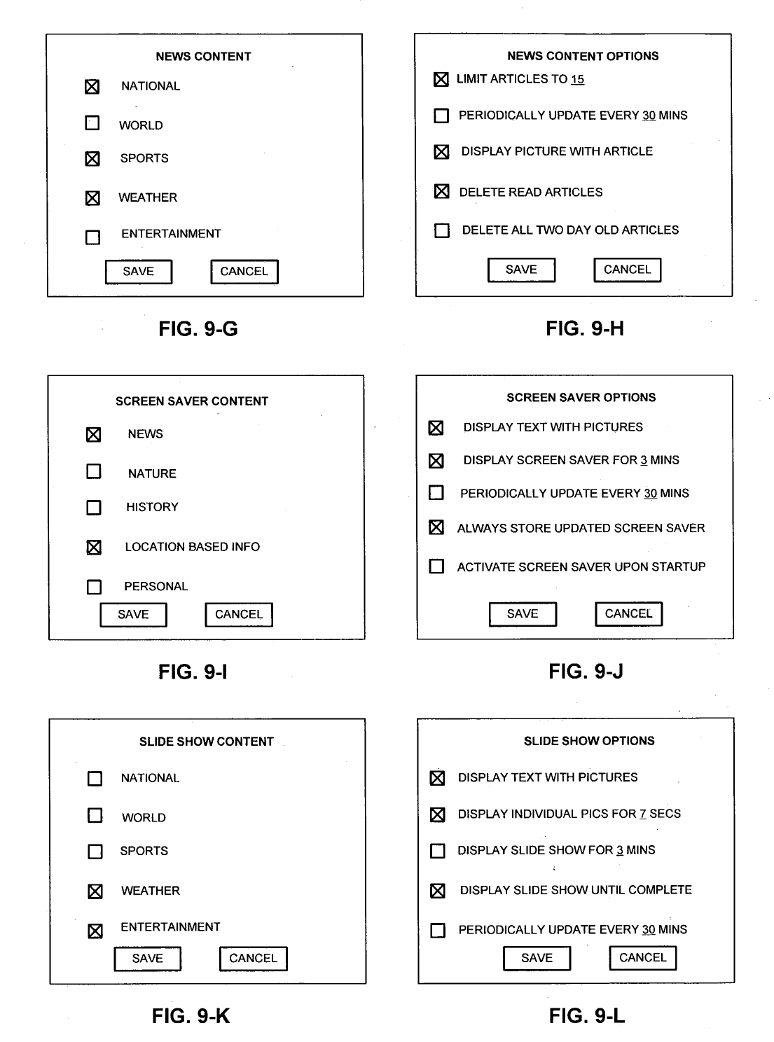

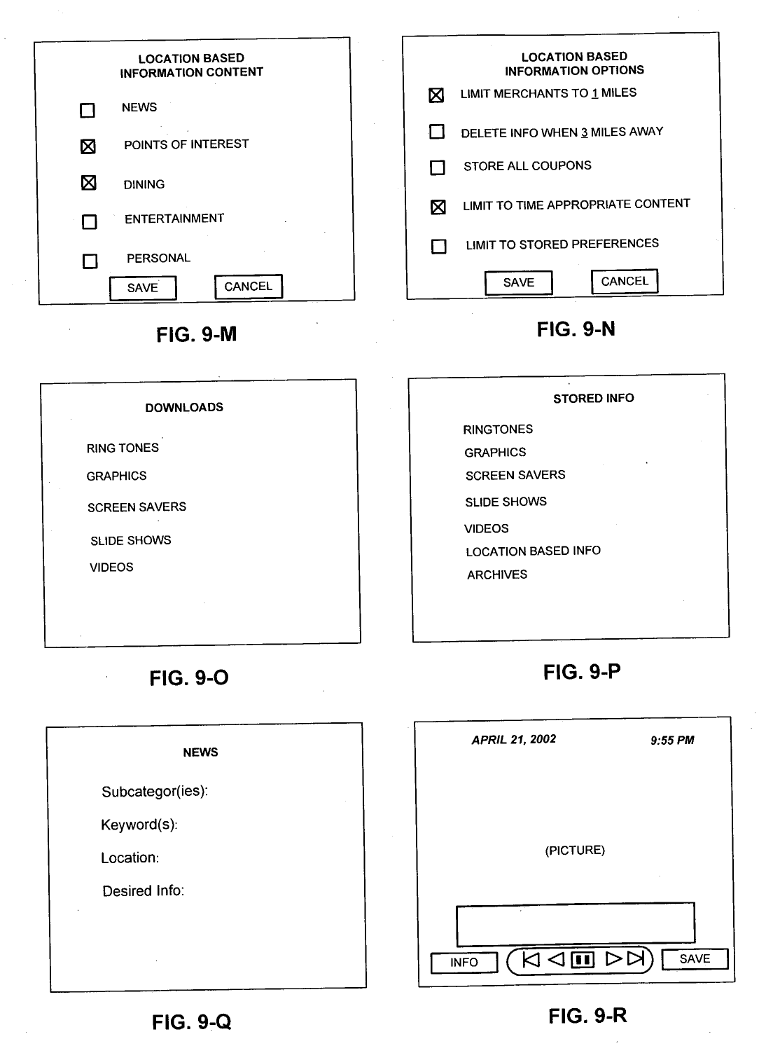

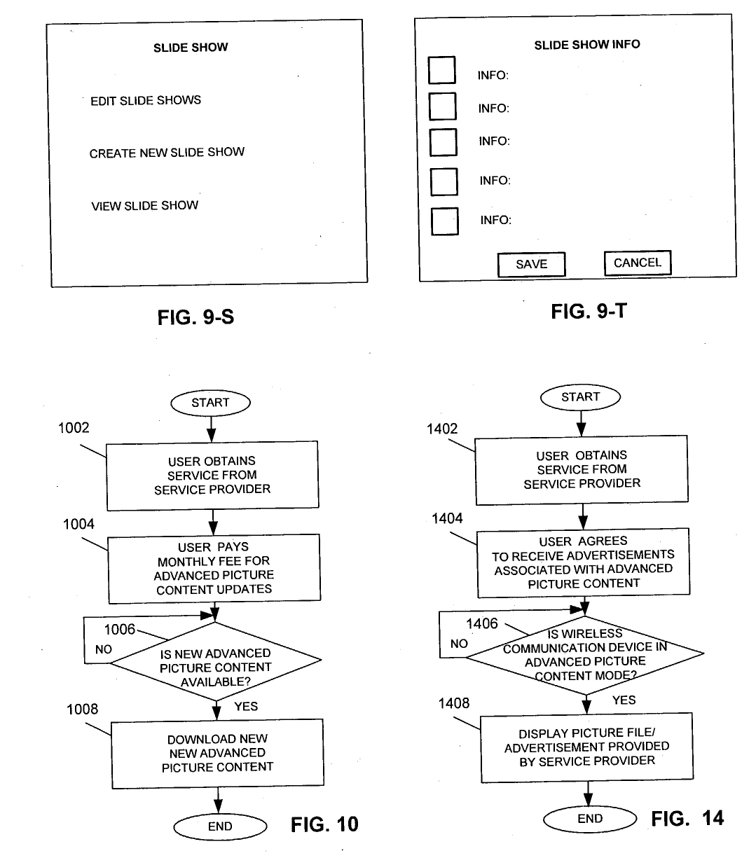

Turning now to FIG. 9, a series of diagrams shows the content of a display according to features of the present disclosure. The content of the displays as shown in any of the figures of FIG. 9 could be employed in any of the devices having a display, such as any device of FIG. 4 having a display. However, it should be understood that the user interface described in reference to FIG. 9 is only a portion of a user interface, and would be incorporated with other features of a wireless communication device. According to one aspect of the present disclosure, which will be described in more detail in reference to remaining figures, information accessible or displayed on the Wireless Communication Device 416 by way of the Wireless Communication Network 404 can “mirror” information which is accessible on another device, such as the portable computer 412 or the landline networked computer 422 of FIG. 4. That is, the user preferences, service options, display options, content options, or other aspects of services or features described in the present disclosure can be selected or set by way of the Wireless Communication Device 416, or a webpage accessible by the user on another device, such as the portable computer 412 or the landline networked computer 422 of FIG. 4.

Referring specifically to the displays of FIG. 9, an exemplary display shown in FIG. 9-A shows a display of the Wireless Communication Device 416, which preferably shows a time and date, as well as a menu selection and selection for various features according to the present disclosure. As is well known in the art, the menu or features can be selected by using various selector keys on the wireless communication device.

As shown in FIG. 9-B, a webpage accessible by a user of the Wireless Communication Device 416 can be accessed on the Internet and entered by way of a log-in feature requiring a user name and personal identification number (PIN). Accordingly, when the user enters the menu selection in FIG. 9-A or enters the user's personal webpage by entering the log-in information in FIG. 9-B, the user accesses the features or services of the present disclosure. Preferably, the content provided when accessing features or services either by way of the wireless communication device or the webpage is identical. However, it is contemplated that additional information could be shown on the webpage, assuming that the user would access the webpage from a device having a more suitable display for displaying additional information.

Turning now to FIG. 9-C, the remaining displays of FIG. 9 could be accessible for either the wireless communication device 416 or a webpage accessible by the user. An example of a menu of FIG. 9-C showing features of the present invention could be shown initially. For example, synchronization, bill info, service options, downloads, and stored info are five options which may be available to a user to access or employ features of the present disclosure. Also shown in the dashed box of FIG. 9-C are options which could be selected by the user on the webpage to indicate that the features should be displayed on the Wireless Communication Device 416. That is, a user could designate certain features which should be displayed on the wireless communication device, which may have a generally smaller screen and be less able to accommodate large amounts of information.

Turning now to FIG. 9-D, a display showing the synchronizing feature of FIG. 9-C is shown. In particular, a user could set a number of preferences for synchronizing the Wireless Communication Device 416 with the account information which would be displayed on the webpage of the user. For example, the user could select a requirement that only local synchronization is used. In particular, local synchronization would be a short-range synchronization between the Wireless Communication Device 416 and a user's webpage. Such a local synchronization could prevent or avoid any undesired disclosure of information which could occur if the synchronization is performed by way of a wireless communication network. Alternatively, as shown in the dashed boxes, the user could select an over-the-air (OTA) synchronization, and an automatic synchronization upon power-up. Such synchronization preferences would provide automatic synchronizing between the devices. The display could also include other synchronization features, such as a feature where the wireless communication device overrides the webpage when synchronization is performed. In such a circumstance, the preferences selected on a wireless communication device would override preferences selected on the webpage. Finally, icons for performing the synchronization or canceling the changes could be provided. As with any option or feature of the present disclosure, the selection of selection boxes and the selection of icons, such as “Sync” or “Cancel,” could be selected by a touch-screen display or by using keys on the keypad, with a suitable user interface.

Turning now to FIG. 9-E, an exemplary “Bill Info” screen is shown. In particular, the “Bill Info” screen would show the current status of a bill, as well as the features selected and associated monthly costs with the features. As shown in FIG. 9-E, a 350-minute package for $29.95 is shown. The current minutes, as well as any minutes over the allocated 350 minutes could also be displayed. Because only 327 minutes are currently used, no additional minutes are shown, and a corresponding cost of $0 is shown. Also shown are a number of features available to the user, some of which are shown as selected. For example, real-time news for $3.00 per month, a monthly screensaver feature for $1.00 per month, and location-based information for $2.00 pmer month is shown. Although additional features such as slide shows and streaming videos are not selected, the user could select those at a later time. Accordingly, the monthly total of $35.95 is shown. Preferably, an outstanding balance could also be shown.

It is also contemplated by the present disclosure that a current monthly total could be updated by the selection of an “Update” button as well as an online payment could be made by the selection of an “Online Payment” button. In addition to providing real-time data related to an end user's bill, the Bill Info screen could also be used to change features, as well as provide a new estimated monthly total for the selected features. That is, if an additional feature is selected, the cost of the feature as well as the monthly total could be shown. When the “Online Payment” button is selected, the user can select one of a number of credit cards which may be entered for the user, as well as select the amount and date of payment, either directly from the wireless communication device, or a webpage associated with the user. As has been previously described, the Bill Info information, like the remaining features shown in the remaining displays of FIG. 9, could be accessible on the Wireless Communication Device 416, or a webpage accessible by a user associated with the wireless service provider. Finaly, other novel features of billing could be employed, such as only charging a user when advanced picture content from a service provided is opened. Such charges could also be displayed as described above.

Turning now to FIG. 9-F, a “Service Options” feature is described. Such a display would enable a user to select various features for providing advanced picture content to a user of a wireless communication device. As will be described in more detail in reference to remaining figures, advanced picture content could be the transmission of any type of picture, icon, graphic, or other picture file in any standard format, such as JPEG, GIF, TIFF, or some other standard or proprietary format. The various service options, such as news, screensavers, slide shows, location-based information, or streaming videos, could be selected by selecting a box adjacent to the option. Similarly, various options for displaying content provided to the wireless communication device can be selected. The available content and options for each service option sown in FIG. 9-F will be described in more detail in reference to remaining displays of FIG. 9. As shown in FIG. 9-F, a “Save” or “Cancel” icon can be selected to save changes to the Service Options selections, or cancel any changes as desired.

Exemplary content selections and content options for news are shown in FIGS. 9-G and 9-H. In particular, various categories for news content can be selected, such as national, world, sports, weather and entertainment shown in FIG. 9-G. Similarly, options for displaying the news content can be selected, as shown in FIG. 9H. Optionally, up and down arrows could be provided on the display adjacent to the number to enable the user to easily change the number. For example, a user could select to limit the number of articles of news provided to the wireless communication device to a user-selectable number, such as 15, as shown in FIG. 9-H. Similarly, a user could select the period of update, whether to display a picture with each article, an option to delete “read” articles or delete old articles. As with the remaining content/options for various features of the present disclosure, the subject matter of the content and the various options available to a user to display the content, such as that shown in FIGS. 9G and 9-H, are merely exemplary. It is understood that fewer or additional content or options could be provided to a user.

Turning now to FIGS. 9-I and 9-J, content and options for displaying screensaver information are shown. As with the news content of FIG. 9-G, various content for screensaver information can be selected in FIG. 9-I. Such screensavers can provide news information which can be displayed on the Wireless Communication Device 416 when it is in a screensaver mode. Generally, the screensaver feature of the Wireless Communication Device 416 would enable the sequential display of a plurality of screens of news content according to options selected by the user. Preferably, the selected content for screensavers would be displayed with picture files and information related to the picture files. Alternatively, information with standard backgrounds could be provided, and a picture file could be accessed if desired and available. For example, news information or location-based information could be provided in a screensaver format, and automatically displayed on a wireless communication device when it has entered a screensaver mode. The screensaver would then be displayed according to options selected by the user, such as those shown, for example, in FIG. 9-J. In particular, a user could select to display text with pictures, display the screensaver for a user-selectable period of time, periodically update the screensavers after a user-selectable period of time, store updated screensaver information for use when the wireless communication device is not within range of the wireless communication network providing the screensaver service, or to automatically activate a screensaver upon start-up of the wireless communication device. It is contemplated that other content and options for screensavers could be employed according to the present disclosure, and more detailed information applicable to the operation of the screensaver feature of a wireless communication device according to the present disclosure will be disclosed in reference to remaining flowcharts.

Turning now to FIGS. 9-K and 9-L, a slide show feature of a wireless communication device and slide show service of a wireless communication network is shown. In particular, a user can select various content for slide shows accessible by a user, and shown according to options selected in FIG. 9-L. For example, the user could select to display text with pictures in the slide show, display individual pictures for a user-selectable period of time, to display a slide show for a user-selectable period, to display a slide show until it is complete, or to periodically update a slide show after a user-selectable period of time. Like screensavers of FIGS. 9-I and 9-J, these slide shows of FIGS. 9-K and 9-L preferably provide advanced picture content and associated information with the picture files of the slide show. Such slide shows would provide entertainment to a user of a wireless communication device who may have a few minutes to spare, and a significant revenue opportunity for a service provider.

Turning now to FIGS. 9-M and 9-N, a location-based information feature according to the present disclosure as described. Various information which is desired based upon the location of the wireless communication device can be selected by the user. For example, a user may desire to receive points of interest or dining information based upon the location of the device. A user may also wish to set certain options affecting the location-based information provided to the user. For example, a user may desire to limit the merchants which could provide location-based information to within one mile of the location of the wireless communication device. The user may also desire to select other options, such as deleting information when the user is outside a user-selectable range of the merchant, storing all coupons provided to the wireless communication device, limiting the location-based information to “time-appropriate” content. For example, a user may only desire an advertisement from a donut shop for a period of time, such as between 6:00 a.m. and 10:00 a.m. Such location-based information can be provided in real time, such as a “pop-up” on a display of a wireless communication device, or accessible by menu selection option enabling access to stored location-based information.

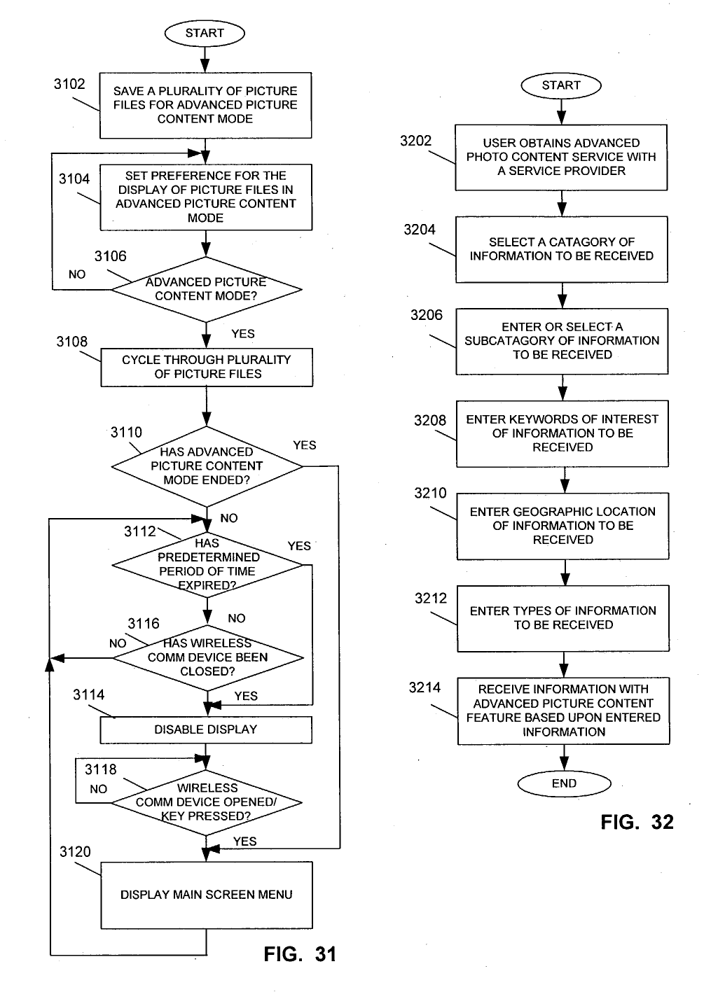

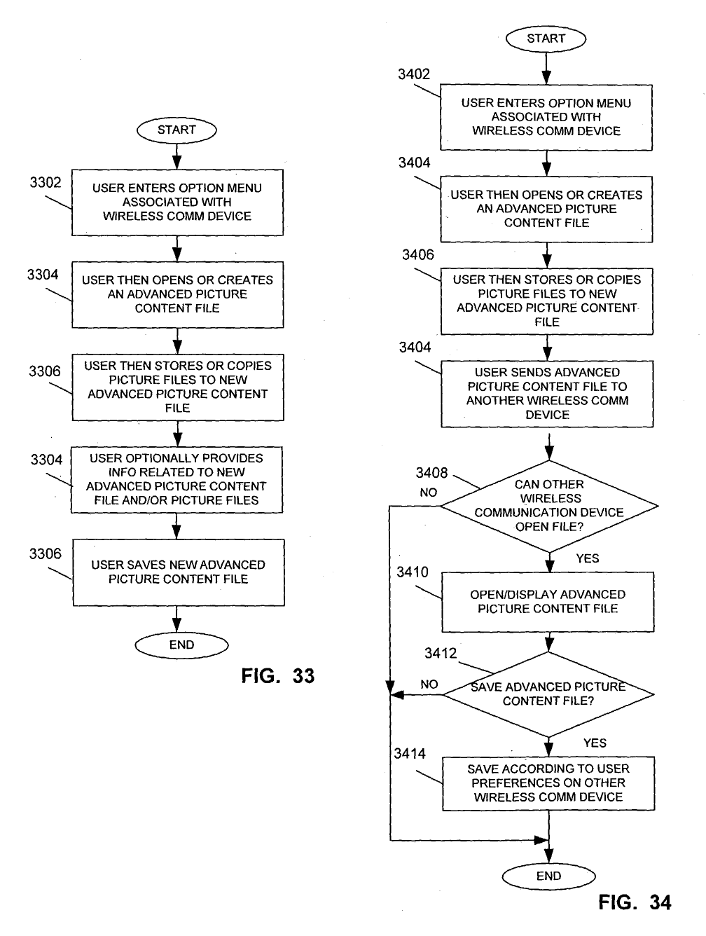

Turning now to FIG. 9-O, a screen enabling access to “downloads” is shown. In particular, a user could select one of a variety of download categories. For example, a user could select to view downloaded information related to ring tones, graphics, screensavers, slide shows, videos, or other content which may be provided to the wireless communication device. Similarly, the user can access stored content, as shown in FIG. 9-P. For example, when a user who receives downloaded information which is accessible through the screen shown in FIGS. 9-O, the user may then select whether to store the information for later retrieval by way of the stored info display of FIG. 9-P. FIG. 9-Q generally shows a screen for customizing content provided to a wireless communication device, and will be described in more detail in reference to FIG. 32.

Turning now to FIG. 9-R, an exemplary display showing a screen of one of the services described above is shown. For example, the display of FIG. 9-Q could show a screen providing news, a screensaver, a slide show, location-based information, or some other advanced picture content provided according to the present disclosure. In particular, a picture file associated with the content is displayed on the screen. Near the bottom of the picture, a block for displaying text is then shown. Preferably, the contrast or color of the background of the block and the text would enable easy reading of the text on the picture. Finally, one or more icons can be selected by the user to enable the user to receive additional information related to the displayed screen. For example, a user could select an “Info” icon to receive additional information on the display, or on the website associated with the user, as provided for by the user in options selected by the user. For example, when the “Info” icon is selected, the additional information may be provided on the display of the device, and/or provided in a file accessible by the user through the website of the user at a later time. Similarly, a user could simply opt to select a “Save” icon to save the information currently shown in the display, for later access, either by way of the wireless communication device or through the website accessible by the user. In addition to showing the “Info” and “Save” icons, a standard “Keypad” for advancing a display of one of the features could be used. For example, user could opt to advance a screen, advance to the last screen, back up a screen, back up to the beginning, or stop the feature, such as when viewing picture files in a slide show. The end selector could be chosen to go to the end of the advanced picture content file, or the pause botton could be “double clicked” to stop. If the end of the advanced picture content file is reached, additional advanced picture content files could be displayed according to the present invention.

Turning now to FIGS. 9-S and 9-T, an exemplary display for creating a slide show on a wireless communication device is shown. A user could select the slide show edit selection from a given menu, enabling the user to either edit, create or view a slide show, for example. A user could then select a picture-file which would be displayed as a thumbnail on the left hand side of the screen, and enter information after the “Info” prompt adjacent the thumbnail as shown in FIG. 9-T. The information would then be displayed when the picture file is displayed according to the advanced picture content feature selected. Although the creation of a slide show is shown in FIGS. 9-S and 9-T, it will be understood that similar screens could be displayed for creating other advanced picture content on the wireless communication device.

Turning now to FIG. 10, a flowchart shows a method of providing advanced picture content according to the present disclosure. Advanced picture content, which generally relates to the provisioning of picture content and/or the provisioning of information with available picture files, includes such features as screensavers, slide shows, location-based information, etc. Various methods described in the present disclosure which relate to advanced picture content are generally independent of the type of content provided, or the format that is provided. For example, various methods described in the present disclosure for features or services on a wireless communication network for providing picture content to a user of a wireless communication device could apply to any type of information, such as news, weather, etc., or the display of information according to various features, such as screensavers, slide shows, location-based information screensavers or slide shows, etc. Accordingly, it will be understood that any method for enabling advanced picture content in the present disclosure could apply to any type of picture content or any picture content displayed in any format described in the present disclosure.

Referring specifically to FIG. 10, a user obtains service from a service provider at a step 1002. Typically, a user signs a contract with a service provider detailing the rates for various airtime and/or features provided by the service provider. The user pays a fee, such as a monthly fee or a “per use” fee, for receiving advanced picture content updates from a service provider at a step 1004. It is then determined whether new advanced picture content is available at a step 1006. Preferably such updates would be periodic, and would relate to a desired subject matter, such as a certain theme. If new advanced picture content is available, the new advanced picture content is downloaded to the user at a step 1008. The new advanced picture content could be downloaded directly to the wireless communication device, or could be provided to the user's website, and subsequently provided to the wireless communication device after a synchronization as is described in this disclosure. It is contemplated that this method or any of the methods in the remaining figures can be performed on a wireless communication device or a wireless communication network described in this disclosure, or any other suitable wireless communication device or network.

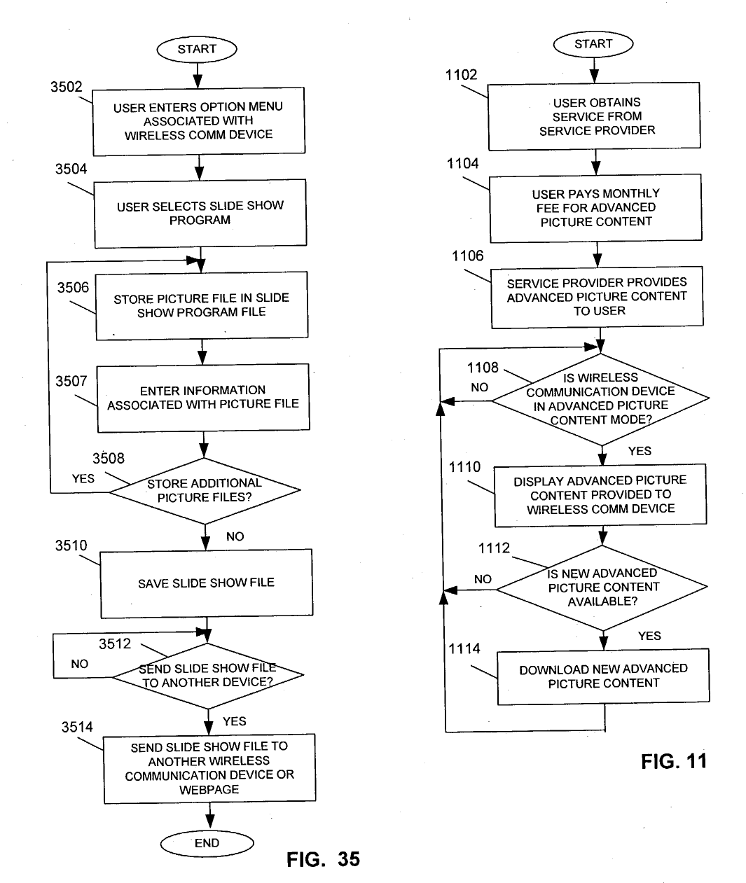

Turning now to FIG. 11, a flowchart shows a more detailed method of providing advanced picture content according to the present invention. A user obtains service from a service provider at a step 1102. The user pays a monthly fee for advanced picture content at step 1104. A service provider provides advanced picture content to the user at a step 1107. The content could be provided directly to the wireless communication device 416, or to a website accessible by the user. It is then determined whether the wireless communication device is in advanced picture content mode at a step 1108. If so, the advanced picture content provided to the wireless communication device is displayed at a step 1110. It is then determined whether new advanced picture content is available at a step 1112. If new content is available, the new content is downloaded to the wireless communication device at a step. 1114.

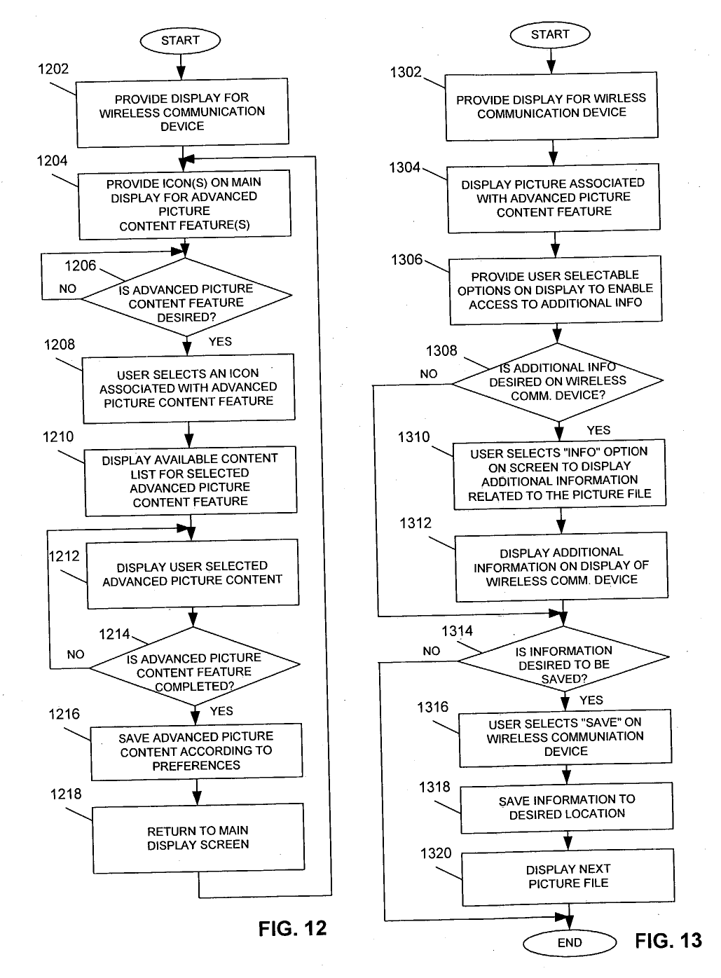

Turning now to FIG. 12, a flowchart shows a method of selecting advanced picture content for display on a wireless communication device. A wireless communication device having a display is provided at a step 1202. Icons are shown on a main display for advanced picture content features at a step 1204. It is then determined whether advanced picture content features are desired at a step 1206. If so, the user selects an icon associated with advanced picture content features at a step 1208. The available content list for the selected advanced picture content feature is then displayed at a step 1210. The user selected advanced picture content is then displayed at a step 1212. It is then determined whether the advanced picture content feature is completed at a step 1214. If so, the advanced picture content is saved according to preferences set by the user at a step 1216, and the wireless communication device returns to the main display screen at a step 1218.

Turning now to FIG. 13, a flowchart shows a method of receiving information associated with an advanced picture content feature according to the present disclosure. In particular, a display for a wireless communication device is provided at a step 1302. A picture file associated with the advanced picture content feature is displayed at a step 1304. User-selectable options are then provided on the display to enable access to additional information at a step 1306. It is then determined whether additional information is desired on the wireless communication device at a step 1308. If addition information is required, the user selects an “Info” option on the screen to display additional information related to the picture file at a step 1310. The information is then displayed on the wireless communication device at a step 1312. Optionally, information could be provided to the user's website for later review. It is contemplated that the information can be provided from the network to the wireless communication device simultaneously with the transmission of the picture file, or could be maintained on a server associated with the wireless communication network, and provided in response to the selection of the “Info” option. It is then determined whether the information is desired to be saved at a step 1314. If so, the user selects a “Save” option on the wireless communication device at a step 1316. The information is then saved to a desired location at a step 1318. For example, the information could be saved on the wireless communication device or on a server of the wireless service provider, and which would be accessible by the user by way of his webpage, or both. If saved at one of the locations, the information that is saved could be transferred to the other location during a synchronization process. The next picture file in the advanced picture content feature is then displayed at a step 1320.

Turning now to FIG. 14, a flow chart shows a method providing advertisements as compensation for providing advanced picture content to a wireless communication device. A user obtains service from a service provider at a step 1402. The user agrees to receive advertisements in lieu of monetary compensation for receiving advanced picture content. It is then determined whether the wireless communication device is in advanced picture content mode. If so, a picture file and advertisement provided by the service provider is displayed on the wireless communication device.

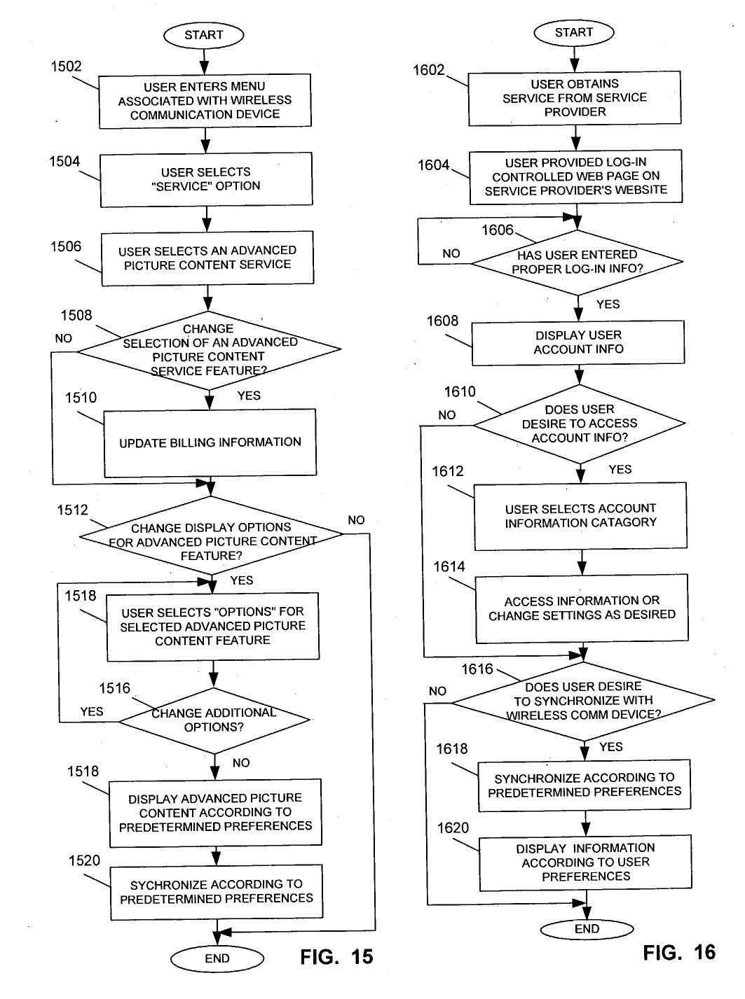

Turning now to FIG. 15, a flowchart shows a method of enabling a user to select advanced picture content services provided by a wireless communication network. In particular, a user enters a menu associated with the wireless communication device at a step 1502. The user then selects a “Service” option at a step 1504. The user then selects an advanced picture content service at a step 1506. The advanced picture content service could be any of the services described in the present disclosure, such as a screensaver, a slide show, location-based information, etc. It is then determined whether the user has changed a selection of an advanced picture content service feature at a step 1508. If so, the billing information is updated at a step 1510. The updated billing information is preferably displayed on the wireless communication device. The updated billing information could also be simultaneously provided to the user's website, or provided to the website upon synchronization as desired by a user. It is then determined whether display options for an advanced picture content feature are changed at a step 1512. If so, the user selects an “Options” button for a predetermined advanced picture content feature at a step 1510. It is then determined whether additional options are changed at a step 1512. If not, the advanced picture content is displayed according to predetermined preferences at a step 1514. The advanced picture content is also synchronized according to predetermined preferences at a step 1516.

Turning now to FIG. 16, a flowchart shows a method of enabling a user to set or change options associated with service provided by the wireless service provider from a remote location. The user obtains service from a service provider at a step 1602. The user is provided with a log-in control webpage on the service provider's website at a step 1604. For example, the user would be required to provide a user name and PIN to access the webpage associated with the service. If the user had entered the proper log-in information, the user account information is provided on a computer at a step 1608. It is then determined whether the user desires to access account information at a step 1610. If so, the user selects an account information category, such as the categories of FIG. 9-C, or a subcategory accessible from that screen at a step 1612. The user then accesses information or changes settings as desired at a step 1614. It is then determined whether the user desires to synchronize any changes with the wireless communication device at a step 1616. If so, the information is synchronized according to predetermined preferences at a step 1618. Information is then displayed according to user preferences at a step 1620.

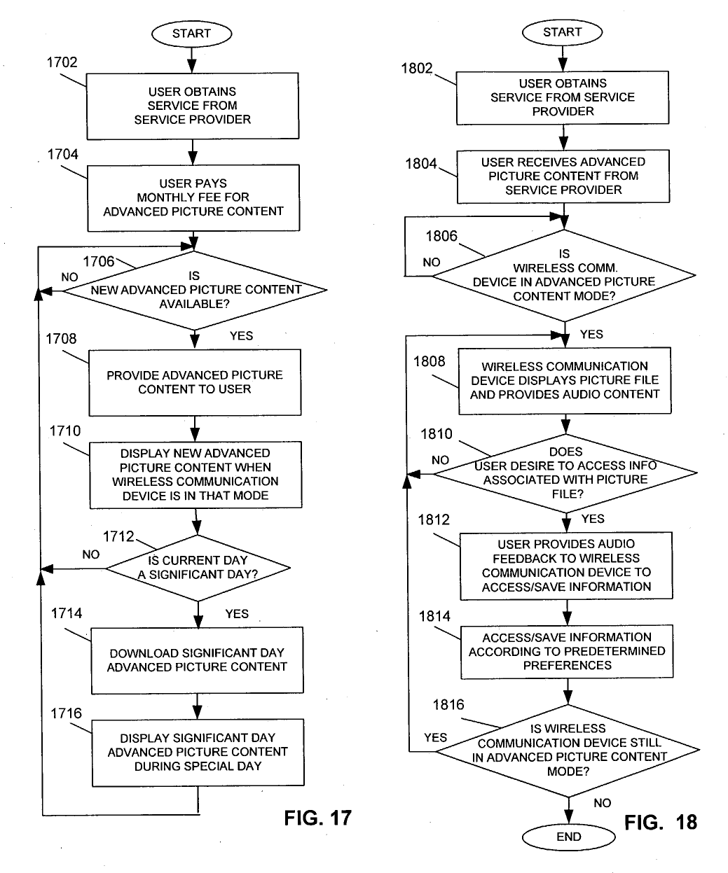

Turning now to FIG. 17, a flowchart shows a method of providing information according to an alternate embodiment of the present disclosure. A user obtains services from a service provider at a step 1702. The user pays a monthly fee for advanced picture content at a step 1704. It is then determined whether new advanced picture content is available at a step 1706. The user is then provided with advanced picture content at a step 1708. The new advanced picture content is displayed when the wireless communication device is in a predetermined mode. It is then determined whether the current day is a significant day at a step 1712. If so, “significant day” advanced picture content is then provided to the wireless communication device at a step 1714. The significant day advanced picture content is then displayed during the significant day according to the selected advanced picture content feature which is operating.

Turning now to FIG. 18, a flowchart shows a method of enabling communication between a user of a wireless communication device and a wireless service provider. In particular, a user obtains service from a service provider at a step 1802. The user receives advanced picture content from a service provider at a step 1804. It is then determined whether the wireless communication device is in advanced picture content mode at a step 1806. If so, the wireless communication device displays a picture file and provides audio content at a step 1808. It is then determined whether the user desires to access information associated with the picture file at a step 1810. If so, the user provides audio feedback to the wireless communication device to access additional information at a step 1812. For example, the user could provide an audio feedback signal by way of a speakerphone to voice-recognition software on the wireless communication device or associated with the wireless service provider. The information is then accessed or saved according to user preferences at a step 1814. It is then determined whether the wireless communication devices is still in the advanced picture content mode at a step 1816.

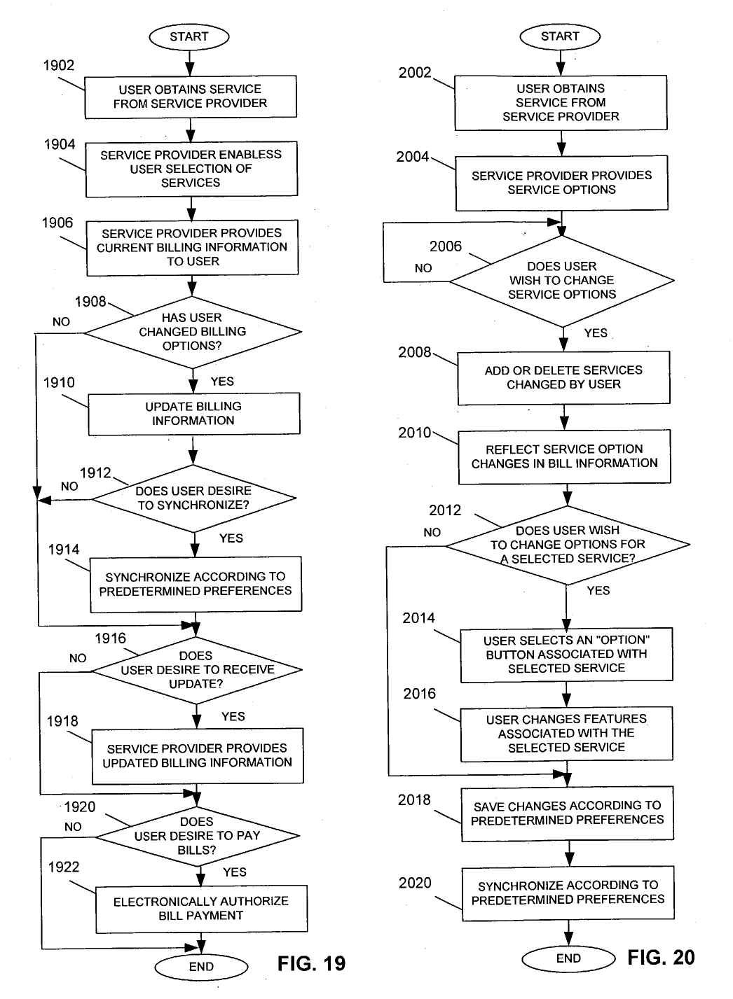

Turning now to FIG. 19, a flowchart shows a method of selecting billing options for wireless communication services according to the present invention. In particular, a user obtains service from a service provider at a step 1902. The service provider enables a user to select services at a step 1904. The services could be selected either on the wireless communication device or by way of a website associated with the wireless service provider. The service provider then provides current billing information to the subscriber at a step 1906. It is then determined whether the subscriber has changed billing options at a step 1908. If so, the updated billing information is provided to the subscriber at a step 1910. It is then determined whether the user desires to synchronize the billing information at a step 1912. That is, depending upon where the user changed the billing information, the updated billing information can then be synchronized to another device at a step 1912. If synchronization is desired, the devices are synchronized according to predetermined preferences at a step 1914. It is then determined whether the user desires to receive updated billing information at a step 1916. The service provider then provides updated billing information at a step 1918. It is also determined whether the user desires to authorize payment of a bill by way of an electronic payment at a step 1920. If so, authorization to pay the bill electronically is provided by way of the wireless communication device at a step 1922.

Turning now to FIG. 20, a flowchart shows a method of selecting service options according to the present disclosure. In particular, a user obtains service from a service provider at a step 2002. The service provider then provides service options to the user at a step 2004. It is then determined whether the user desires to change the service options at a step 2006. If so, services which are changed by the subscriber are then added or deleted at a step 2008. Such changes in service are then reflected in the bill information at a step 2010. It is then determined whether the subscriber wishes to change an option for a selected service at a step 2012. If so, the subscriber selects an “Option” button associated with the selected service at a step 2014. The user then changes features associated with the selected service at a step 2016. The changes are then saved at a step 2018, and synchronized at a step 2020, according to user preferences.

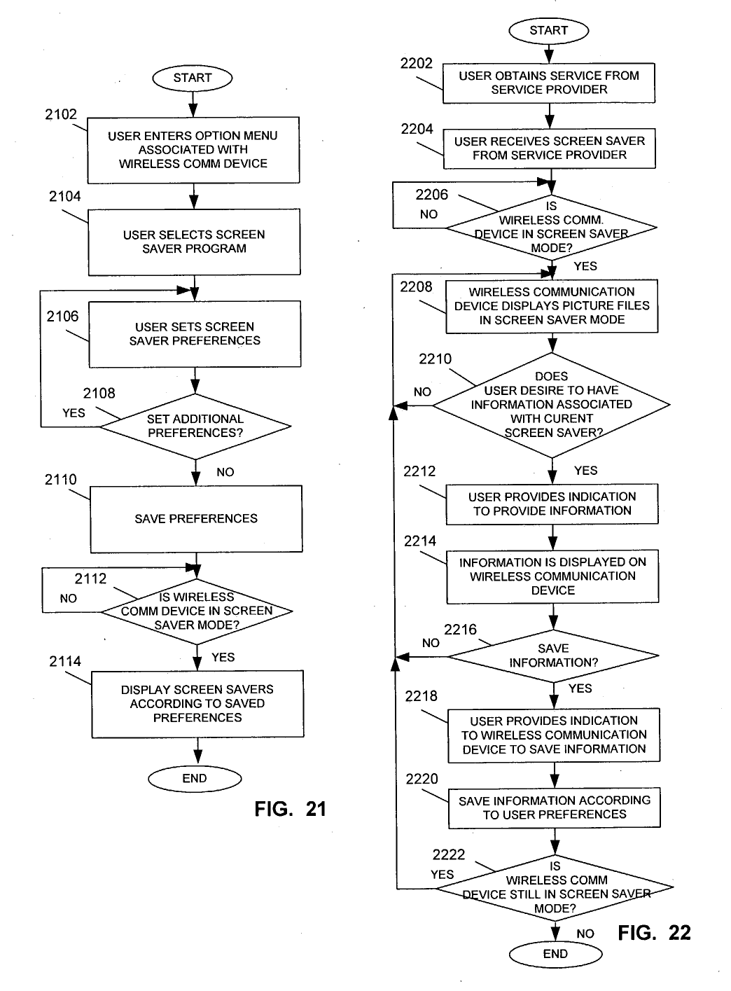

Turning now to FIG. 21, a flowchart shows a method for providing a screensaver service to a wireless communication device according to the present disclosure. A user enters a menu associated with the wireless communication device at a step 2102. The user then selects a screensaver program at a step 2104. The user then sets screensaver preferences at a step 2106. It is then determined whether additional preferences are desired to be set at a step 2108. If not, the set preferences are saved at a step 2110. It is then determined whether the wireless communication device is in screensaver mode at a step 2112. If so, screensavers are displayed according to saved preferences at a step 2114.

Turning now to FIG. 22, a flowchart shows a more detailed method for providing a screensaver to a wireless communication device. A user obtains service from a service provider at a step 2202. The user then receives screensavers from the service provider at a step 2204. It is then determined whether the wireless communication device is in a screensaver mode at a step 2206. The device would enter screen saver mode after the device has been idle for a predetermined period of time. The device could be idle if the device has not been closed (for a clamshell or foldable phone) and/or a key has been selected. If so, the wireless communication device displays picture files in the screensaver mode at a step 2208. It is then determined whether the user desires to have information associated with a picture file being displayed by the predetermined screensaver at a step 2210. If so, the user provides an indication to provide information at a step 2212. For example, the user could select an “Info” option on the display, or provide some other indication by way of a user interface. The desired information is then displayed on the wireless communication device at a step 2214. It is then determined whether the user desires to save the information at a step 2216. If so, the user provides an indication to the wireless communication device to save the information at a step 2218. The information is then saved according to predetermined preferences at a step 2220. For example, the information could be saved either on the wireless communication device or on a server associated with the wireless service provider. It is then determined whether the wireless communication device is still in a screensaver mode at a step 2222. If so, the wireless communication devices displays another picture file in the screensaver mode at the step 2208. If not, the wireless communication device exits screen saver mode. The device could exit screen saver mode due to a time-out or in response to an incoming call for example, in which case a caller ID may be displayed.

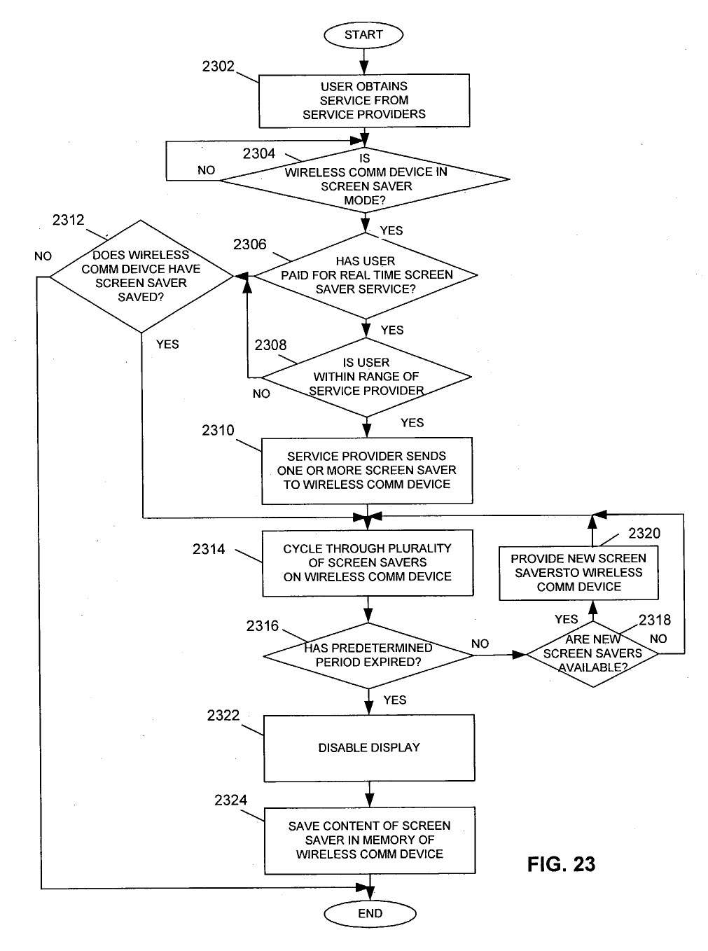

Turning now to FIG. 23, a flowchart shows a method of providing a screensaver on a wireless communication device according to an alternate embodiment of the present disclosure. A user obtains service from a service provider at a step 2302. It is then determined whether the wireless communication device is in screensaver mode at a step 2304. If so, it is determined whether the subscriber has paid for “real-time” screensaver service at a step 2306. The real-time screensaver service preferably provides real-time information according to a category selected by a user as described above. Real time information generally means information which is time dependent and/or updated periodically, and is not limited to instantaneous information. It is then determined whether the user is within range of the service provider at a step 2308. If so, the service provider sends one or more screensavers having real-time information to the wireless communication device at a step 2310. If not, it is then determined whether the wireless communication device has screensavers which are stored at a step 2312. If the service provider is able to send real-time screensavers, or the wireless communication device has a screensaver which is stored, the wireless communication device then cycles through a plurality of picture files associated with the screensaver on the wireless communication device at a step 2314. It is then determined whether a predetermined period of time has expired at a step 2316. If not, it is determined whether new real-time screensavers are available at a step 2318. If so, the new screensavers are provided to the wireless communication device at a step 2320. However, if the predetermined period of time has expired at the step 2316, the display is disabled at a step 2322, and the content of the screensaver is saved in a memory of the wireless communication device at a step 2324. The display is preferably disabled or placed in a low power mode to minimize power consumption.

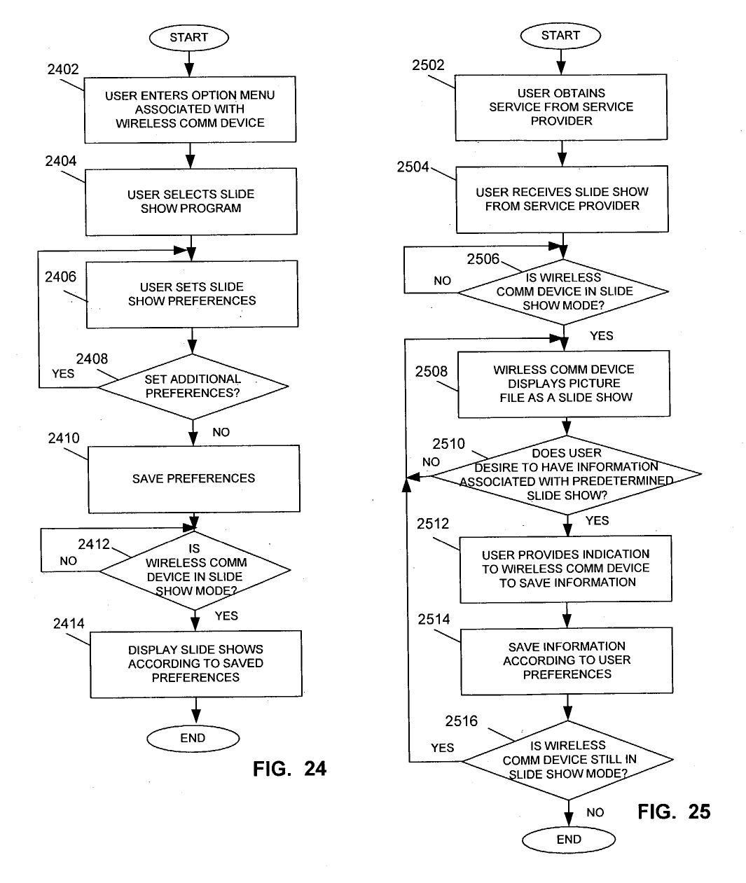

Turning now to FIG. 24, a flowchart shows a method for providing a slide show service to a wireless communication device according to the present disclosure. A user enters a menu associated with the wireless communication device at a step 2402. The user then selects a slide show program at a step 2404. The user then sets slide show preferences at a step 2406. It is then determined whether additional preferences are desired to be set at a step 2408. If not, the set preferences are saved at a step 2410. It is then determined whether the wireless communication device is in slide show mode at a step 2412. If so, slide shows are displayed according to saved preferences at a step 2414.

Turning now to FIG. 25, a flowchart shows a more detailed method for providing a slide show to a wireless communication device. A user obtains service from a service provider at a step 2502. The user then receives slide shows from the service provider at a step 2504. It is then determined whether the wireless communication device is in a slide show mode at a step 2506. If so, the wireless communication device displays picture files in the slide show mode at a step 2508. It is then determined whether the user desires to have information associated with a picture file being displayed by the predetermined slide show at a step 2510. If so, the user provides an indication to provide information at a step 2512. For example, the user could select an “Info” option on the display, or provide some other indication by way of a user interface. The desired information is then displayed on the wireless communication device at a step 2514. It is then determined whether the user desires to save the information at a step 2516. If so, the user provides an indication to the wireless communication device to save the information at a step 2518. The information is then saved according to predetermined preferences at a step 2520. For example, the information could be saved either on the wireless communication device or on a server associated with the wireless service provider. It is then determined whether the wireless communication device is still in a slide show mode at a step 2522. If so, the wireless communication devices displays another picture file in the slide show mode at the step 2508.

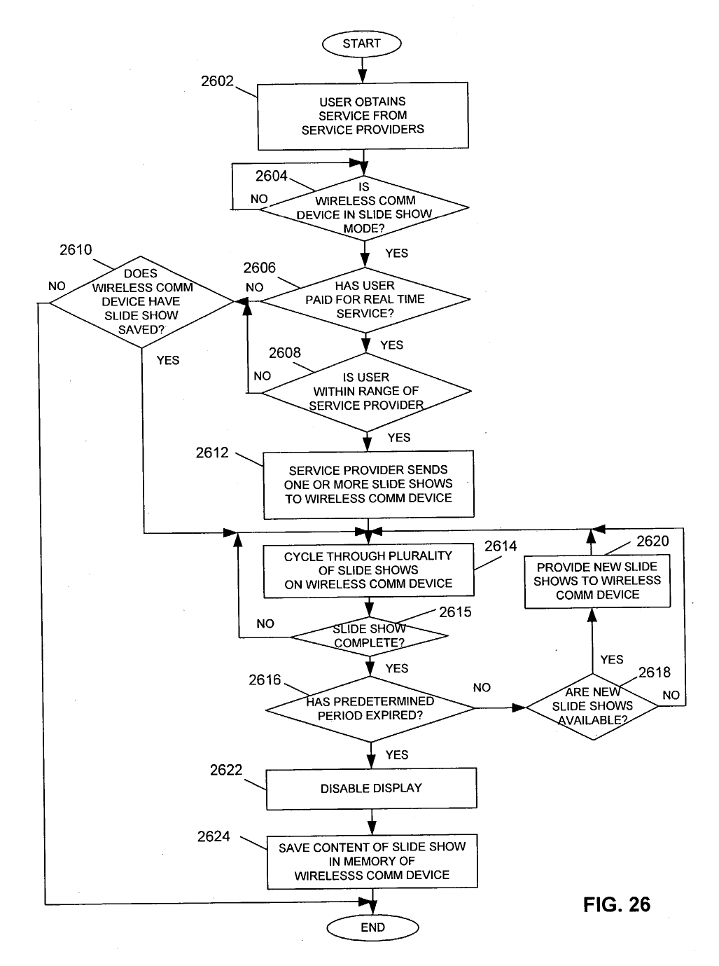

Turning now to FIG. 26, a flowchart shows a method of providing a slide show on a wireless communication device according to the present disclosure. A user obtains service from a service provider at a step 2602. It is then determined whether the wireless communication device is in slide show mode at a step 2604. If so, it is determined whether the subscriber has paid for “real-time” slide show service at a step 2606. The real-time slide show service preferably provides real-time, or at least current, information according to a category selected by a user as described above. It is then determined whether the user is within range of the service provider at a step 2608. If so, the service provider sends one or more slide shows having real-time information to the wireless communication device at a step 2610. If not, it is then determined whether the wireless communication device has slide shows which are stored at a step 2612. If the service provider is able to send real-time slide shows, or the wireless communication device has a slide show which is stored, the wireless communication device then cycles through a plurality of picture files associated with the slide show on the wireless communication device at a step 2614. It is then determined whether the slide show is complete at a step 2615. It is then determined whether a predetermined period of time has expired at a step 2616. If not, it is determined whether new real-time slide shows are available at a step 2618. If so, the new slide shows are provided to the wireless communication device at a step 2620. However, if the predetermined period of time has expired at the step 23-16, the display is disabled at a step 2622, and the content of the slide show is saved in a memory of the wireless communication device at a step 2624.

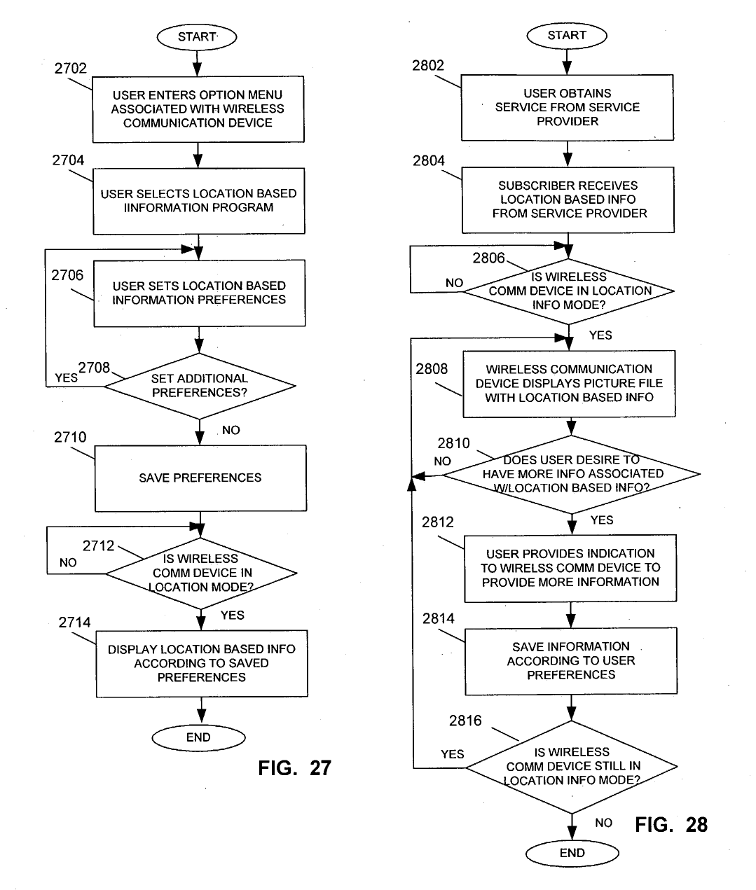

Turning now to FIG. 27, a flowchart shows a method for providing a location based information service to a wireless communication device according to the present disclosure. A user enters a menu associated with the wireless communication device at a step 2702. The user then selects a location based information program at a step 2704. The user then sets location based information preferences at a step 2706. It is then determined whether additional preferences are desired to be set at a step 2708. If not, the set preferences are saved at a step 2710. It is then determined whether the wireless communication device is in location based information mode at a step 2712. If so, location based information is displayed according to saved preferences at a step 2714.

Turning now to FIG. 28, a flowchart shows a more detailed method for providing a location based information to a wireless communication device. A user obtains service from a service provider at a step 2802. The user then receives location based information from the service provider at a step 2804. It is then determined whether the wireless communication device is in a location based information mode at a step 2806. If so, the wireless communication device displays picture files in the location based information mode at a step 2808. It is then determined whether the user desires to have information associated with a picture file being displayed by the predetermined location based information at a step 2810. If so, the user provides an indication to provide information at a step 2812. For example, the user could select an “Info” option on the display, or provide some other indication by way of a user interface. The desired information is then displayed on the wireless communication device at a step 2814. It is then determined whether the user desires to save the information at a step 2816. If so, the user provides an indication to the wireless communication device to save the information at a step 2818. The information is then saved according to predetermined preferences at a step 2820. For example, the information could be saved either on the wireless communication device or on a server associated with the wireless service provider. It is then determined whether the wireless communication device is still in a location based information mode at a step 2822. If so, the wireless communication devices displays another picture file in the location based information mode at the step 2808.

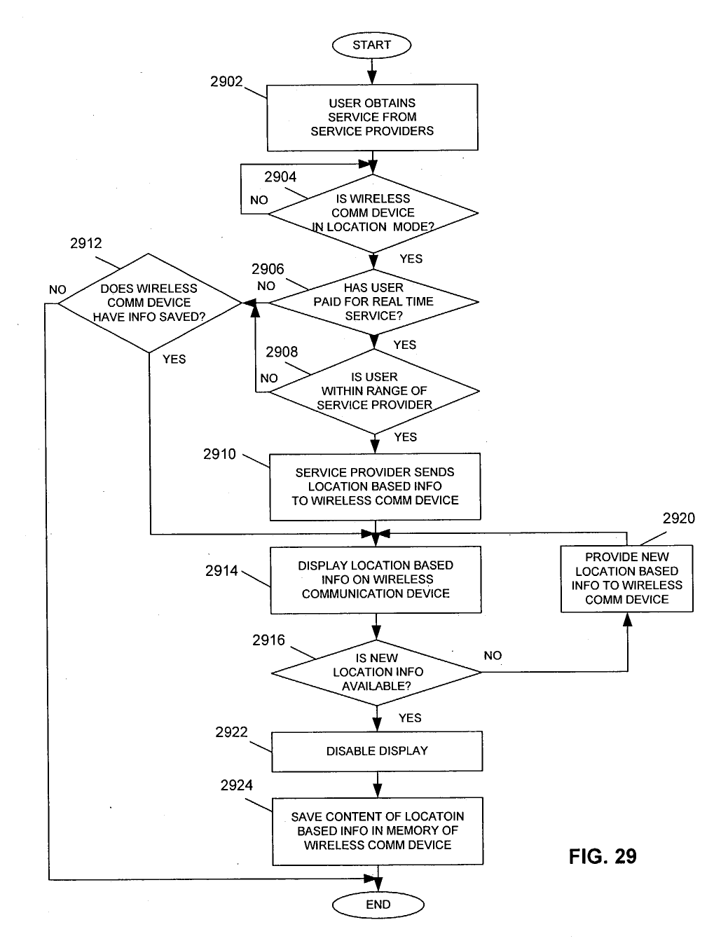

Turning now to FIG. 29, a flowchart shows a method of providing location based information on a wireless communication device according to the present disclosure. A user obtains service from a service provider at a step 2902. It is then determined whether the wireless communication device is in location based information mode at a step 2904. If so, it is determined whether the subscriber has paid for “realtime” location based information service at a step 2906. The real-time location based information service preferably provides real-time, or at least current, information according to a category selected by a user as described above. It is then determined whether the user is within range of the service provider at a step 2908. If so, the service provider sends one or more location based information having real-time information to the wireless communication device at a step 2910. If not, it is then determined whether the wireless communication device has location based information which are stored at a step 2912. If the service provider is able to send real-time location based information, or the wireless communication device has a location based information which is stored, the wireless communication device then cycles through a plurality of picture files associated with the location based information on the wireless communication device at a step 2914. It is then determined whether new location information is available at a step 2916. If so, the new location based information are provided to the wireless communication device at a step 2920. However, if the predetermined period of time has expired at the step 2916, the display is disabled at a step 2922, and the content of the location based information is saved in a memory of the wireless communication device at a step 2924.

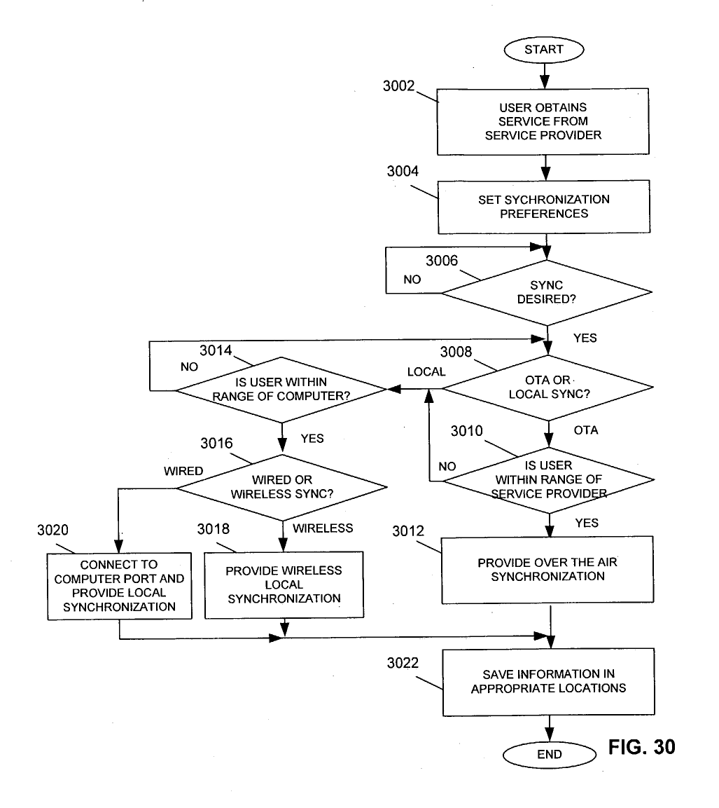

Turning now to FIG. 30 a flow chart shows a method for synchronizing information between a wireless communication device and another device, such as a web page associated with the users service. In particular, a user obtain service from a service provider at a step 3002. The user then sets synchronization preference at a step 3004. It is then determined whether synchronization is desired at a step 3006. Synchronization could be initiated at the request of the user, or automatically by the wireless communication device, depending upon preferences set by the user. It is then determined whether over the air (OTA) or local synchronization is desired at a step 3008. If over the air synchronization is desired, it is determined whether the wireless communication device is within the range of a service provider at a step 3010. If the wireless communication device is within range of the service provider, the over the air synchronization is performed at a step 3012. However, if the user is not within range, or local synchronization is required, it is determined whether the wireless communication device is within range of a computer at a step 3014. If so, it is then determined whether wired or wireless synchronization is desired at a step 3016. If wireless synchronization is desired, wireless local synchronization is performed at a step 3018. Such local synchronization could be, for example, by a low power local connection, such as infrared, BlueTooth, I.E.E.E. 802.11 or some other short range wireless communication protocol. However, if the user desires a wired synchronization, the user connects the wireless communication device to a computer port and provides local synchronization at a step 3020. The wired synchronization could be performed by any wired protocol, such as an IRS-232 connection or some other protocol.

Turning now to FIG. 31, a flow chart shows a method of saving power in a wireless communication device providing advance picture content. In particular, a plurality of picture files are in advance picture content mode are provided at a step 3102. Preferences for the display of picture files in the advance picture content mode are set a step 3104. It is then determined whether a wireless communication device is in the advance picture content mode at a step 3106. If so, the wireless communication device cycles through a plurality of picture files at a step 3108. It is then determined whether advanced picture content mode has ended at a step 3110. If not, it is then determined whether a predetermined period of time has expired at a step 3112. If so, the display of the wireless communication device is disabled at a step 3114. However, if the predetermined period of time has not expired at the step 3112, it is determined whether the wireless communication devices been closed at a step 3116. If so, the display of the wireless communication devices are disabled at a step 3114. Preferably when the display is disabled, the screen is either deactivated, or placed in a low power mode to reduce power consumption. After the display is disabled, it is determined whether the wireless communication device has been opened or (for a phone not having a hinge) whether a key has been pressed at a step 3118. If so, the wireless communication device displays a main menu at a step 3120.

Turning now to FIG. 32, a flow chart shows a method of customizing advanced picture content received by a wireless communication device according to the present invention. In particular, a user obtains advance picture content service from a service provider at step 3202. The user then select a category of information to be received at a step 3204. The category of information could be associated with any advance picture content service, such as a screen saver, a slide show, location based information, or some other advance picture content feature. For example, a user could select a particular category in FIG. 9-G, 9-I, 9-K, or 9-M by “double clicking” on the category. Double clicking on “NEWS” in FIG. 9-I could lead to FIG. 9-Q. The user then enters or selects a subcategory of information to be received at a step 3206. The user may then enter key words of interest of information to be received at a step 3208. The user may then enter geographic location of information to be received at a step 3010. Finally, the user enters the type of information to be received at a step 3211. The user then receives the information with advance picture content feature based upon the entered information at a step 3014. For example, the user may select a category of news, having a subcategory of local news, having a key word of interest being “politics”. The user may then enter a geographic location of a certain city of interest, and enter the type of information such as “news articles” to be received. The entries in FIG. 9-Q could bd manually entered by the user, or accessed from a pull-down menu of options established by the service provider. Accordingly, a user can tailor the information which is received for any one of the advanced picture content features, which may also enable an advertiser to provide better targeted advertisements.

Advanced picture content could be created by a particular entity (such as a company) for an end user (such as employees or customers). Alternatively, advanced picture content could include picture files associated with a particular entity or theme or category. For example, a toolbar could specific to a particular company (e.g. hotel chain promoting vacation spots), university, profession, sport, team, nationality, etc. Alternatively, the advanced picture content could include picture files related to seasons, months of the year. Such peroidic update of advanced picture content, such as dialy, weekly or monthly, could be stored in the memory and automatically stored in place of outdated advanced picture content. Such periodic updates would also provide a way to provide targeted content specific information such as advertisements to end users. Alternatively, the updates could be provided when the service provider detects that the user has accesses advanced picture content and should be provided an update instanteously. That is, rather than store the updates, the service provider would provide the updates as needed or in response to a request from the user or the wireless communication devide.

Turning now to FIG. 33, a flow chart shows a method of creating advanced picture content on a wireless communication device. In particular, a user enters an option menu associated with a wireless communication device at a step 3302. The user then opens or creates an advance picture content file at a step 3304. The user then moves or copies a picture file to the new advanced picture content file at a step 3306. The user then optionally stores information associated with the picture file at a step 3308. These are then save the picture file and any information in the advanced picture content file at a step 3310. An advanced picture content file could also be set up on a user website and provided to a wireless communication device on a communication link.

Turning now to FIG. 34, a more detail method for creating an advanced picture content file on a wireless communication device as shown. In particular, a user enters an option mention associated with the wireless communication device at a step 3502. The user opens or creates an advance picture file at a step 3404. The user then moves or copy picture file to the new advanced picture file at a step 3406. The user can optionally store information associated with each picture file. The user then stores the advance picture content file in the wireless communication device in a step 3408. The user then sends the advanced picture content file to another wireless communication device at a step 3410. It is then determined whether the other wireless communication device can open the file at a step 3412. If so, the user of the other wireless communication device opens the file and displays the advanced picture content at a step 3414. It is then determined whether the user desires to save the advance picture content at a step 3416. If so, the user saves the advanced picture content file at a step 3418.

Turning now to FIG. 35, a flow chart shows a method of creating a slide show on a wireless communication device according to the present invention. In particular, a user enters an option menu associated with the wireless communication device at a step 3502. The user then selects a slide show program at a step 3504. The user then opens an existing slide show file or creates a new slide show file and saves a picture file to the new slide show at a step 3506. The user then preferably enters information associated with a new picture file at a step 3507. It is then determined whether additional picture files and information are intended to be stored at a step 3508. If not, the new slide show file is then saved at a step 3510. It is then determined whether the user desires to send the slide show at a step 3512. If so, the slide show is then transmitted to another device at a step 3514. The slide show could be sent by way of any of the communication links, such as any of the communication links from the wireless communication device 416 to any other device of FIG. 4. For example, the new slide show could be transmitted from the wireless communication device 416 to the wireless communication device 418 by way of the wireless communication network. Assuming that the wireless communication device 418 is capable of displaying a slide show, the wireless communication device could open the slide show and display it on its display. The wireless communication device 418 could then save the new slide show, or synchronize with its web page for saving at a different location. Similarly, a slide show could be created on a users website and coupled to the wireless communication device by way of any communication link of FIG. 4.

In summary, the present disclosure relates to method and apparatus for providing information to a wireless communication device. The foregoing discussion of the invention has been presented for purpose of illustration and description. Further, the description is not to limit the invention to the form disclosed herein. Consequently, variations and modifications commensurate with the above teachings within the skill and knowledge of the relevant art, are within the scope of the present invention. The embodiments discussed hereinabove are further intended to explain the best mode known of the invention and to enable others skilled in the art to utilize the invention in such, or in other, embodiments and with the various modification required by their application or uses of the invention. It is intended that the any claims to an invention be constructed to include alternative embodiments to the extent permitted by the prior art.

We claim:

1. A cellular telephone adapted to display account information, said cellular telephone comprising:
a control circuit;
a receiver coupled to said control circuit, said receiver receiving bill information by way of a wireless communication network; and
a display coupled to said control circuit, said display showing said bill information.

2. The cellular telephone of claim 1 wherein said bill information comprising information related to current minutes.

3. The cellular telephone of claim 2 wherein said bill information further comprises information related to an outstanding balance.

4. The cellular telephone of claim 1 wherein said display shows features available to a user.

5. The cellular telephone of claim 4 wherein said display shows features selected by a user.

6. The cellular telephone of claim 5 wherein said display further comprises displaying costs associated with features selected by a user.

7. The cellular telephone of claim 6 wherein said display shows a new estimated monthly cost based upon said costs associated with features selected by a user.

8. The cellular telephone of claim 1 wherein said display shows an update button.

9. The cellular telephone of claim 1 wherein said display shows an online payment button.

10. The cellular telephone of claim 1 wherein said cellular telephone further comprises a voice recognition circuit.
